(19) United States
(12) Patent Application Publication
(10) Pub. No.: US 2026/0197888 A1
(43) Pub. Date: Jul. 9, 2026

(54) METHOD AND APPARATUS FOR COMMUNICATION IN WIRELESS LOCAL AREA NETWORK SYSTEM

(71) Applicant: Samsung Electronics Co., Ltd., Suwon-si (KR)

(72) Inventors: Hyunseob OH, Suwon-si (KR); Kisoo AN, Suwon-si (KR); Junha PARK, Suwon-si (KR)

(21) Appl. No.: 19/443,860

(22) Filed: Jan. 8, 2026

(30) Foreign Application Priority Data
Jan. 9, 2025 (KR) 10-2025-0003368

(51) Int. Cl. H04W 76/15; H04W 84/12

(52) U.S. Cl. CPC H04W 76/15; H04W 84/12

(57) ABSTRACT

A method performed by a first electronic device in a wireless local area network (WLAN) system is provided. The method includes establishing a connection with a second electronic device, based on a first module configured to support a direct connection with the second electronic device for reception of service data, and establishing a connection with at least one third electronic device, based on a second module configured to support a direct connection with the at least one third electronic device for transmission of service data.

This application is based on and claims priority under 35 U.S.C. § 119(a) of a Korean patent application number 10-2025-0003368, filed on January 9, 2025, in the Korean Intellectual Property Office, the disclosure of which is incorporated by reference herein in its entirety.

### BACKGROUND

### 1.Field

The disclosure relates to a method and an apparatus for communication in a wireless local area network (WLAN). More particularly, the disclosure relates to a method and an apparatus for supporting a direct connection between electronic devices based on a Wireless Fidelity (Wi-Fi) connection and improving the quality of a service.

### 2. Description of Related Art

A wireless local area network (WLAN) system is being developed according to various purposes, such as improving a transmission rate, increasing bandwidth, improving reliability, reducing errors, and reducing latency. The Institute of Electrical and Electronics Engineers (IEEE) issues an 802.11 standard specification for the wireless local area network system, and a technology described in the 802.11 standard specification may be referred to as Wi-Fi (or Wireless Fidelity).

Wi-Fi technology has been developed through multiple generations of the 802.11 standard specifications. For example, an 802.11ac standard specification deals with improvements for very high throughput (VHT), an 802.11ax standard specification deals with improvements for high efficiency (HE), and an 802.11be standard specification deals with improvements for extreme high throughput (EHT).

In relation to Wi-Fi technology, various standards and protocols have been developed to support a direct connection between devices. Among them, Wi-Fi Direct and Wi-Fi Aware are technologies designed to enable direct communication between devices without a wireless access point. Wi-Fi Direct is a technology in which one of multiple devices is designated as a group owner, and the device designated as the group owner performs a role of a central manager to perform direct communication with the remaining devices (or group clients). Wi-Fi Direct may be used in various devices, such as smartphones, televisions (TVs), laptops, printers, and cameras, and may be used for various purposes such as file transfer, printer connection, and media sharing. In contrast, Wi-Fi Aware is a technology that enables devices to establish dynamic connections and perform direct communication in a distributed manner without a central manager. A device performs continuous discovery for neighboring devices and performs independent wireless communication between devices, based on a user configuration and a current location. Such direct communication between devices may be used in various applications, such as social networking, gaming, media sharing, and location-based services.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for communication in a wireless LAN system.

Additional aspects will be set forth in part in the description which follows and, in part, will be apparent from the description, or may be learned by practice of the presented embodiments.

In accordance with an aspect of the disclosure, a first electronic device in a wireless local area network (WLAN) system is provided. The first electronic device includes at least one transceiver, memory, comprising one or more storage media, storing instructions, and at least one processor connected to the at least one transceiver and the memory, wherein the at least one processor comprises, a first module configured to support a direct connection with a second electronic device for reception of service data, and a second module configured to support a direct connection with at least one third electronic device for transmission of service data.

In accordance with an aspect of the disclosure, a method performed by a first electronic device in a wireless local area network (WLAN) system is provided. The method includes establishing a connection with a second electronic device, based on a first module configured to support a direct connection with the second electronic device for reception of service data, and establishing a connection with at least one third electronic device, based on a second module configured to support a direct connection with the at least one third electronic device for transmission of service data.

The first module is configured to support a client in direct wireless communication between devices via a central manager without a wireless access point, the second module is configured to support an owner in direct wireless communication between devices via a central manager without a wireless access point, and the first module and the second module are included in an identical chipset or included in different chipsets, respectively.

The first module is configured to support direct wireless communication between devices in a distributed manner without a wireless access point and a central manager, the second module is configured to support an owner in direct wireless communication between devices via a central manager without a wireless access point, and the first module and the second module are included in an identical chipset.

The first module and the second module are configured to support direct wireless communication between devices in a distributed manner without a wireless access point and a central manager, and the first module and the second module are included in an identical chipset.

The method further includes receiving service data for a first service from the second electronic device, and transmitting service data for a second service to the at least one third electronic device.

The method further includes transmitting a first signal for measuring a quality of a connection to the at least one third electronic device, receiving a second signal including a measurement value for the first signal from the at least one third electronic device, selecting a communication mode for the second module, based on the measurement value, and transmitting service data to the at least one third electronic device, based on the selected communication mode.

The selected communication mode includes one of a first communication mode using a link configured based on a single bandwidth for multiple transmission-reception antenna pairs, and a second communication mode using multiple links corresponding to different frequency bands for the respective transmission-reception antenna pairs, the first communication mode includes a multiple input multiple output (MIMO) mode, and the second communication mode includes a multiple link operation (MLO) mode.

The method further includes determining whether a condition for evaluating a communication mode is satisfied, wherein the first signal for measuring the quality of the connection is transmitted in case that the condition is satisfied. The condition includes at least one of a condition in which a new service is initiated, a condition in which an existing service is terminated, a condition in which an amount of data traffic changes by a threshold value or more, and a condition in which a pre-configured time period starts. In addition, the first signal includes a pilot packet not including service data or a beacon signal based on Wi-Fi.

In accordance with an aspect of the disclosure, one or more non-transitory computer-readable storage media storing one or more computer programs including computer-executable instructions that, when executed by one or more processors of an electronic device individually or collectively, cause the electronic device to perform operations are provided. The operations include establishing a connection with a second electronic device, based on a first module configured to support a direct connection with the second electronic device for reception of service data, and establishing a connection with at least one third electronic device, based on a second module configured to support a direct connection with the at least one third electronic device for transmission of service data.

By the method and the apparatus according to embodiments of the disclosure, various services using Wi-Fi may be effectively supported in a wireless LAN system.

By the method and the apparatus according to embodiments of the disclosure, the quality of a service in wireless communication using Wi-Fi may be improved in a wireless LAN system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a configuration of a device for wireless communication according to an embodiment of the disclosure;

FIG. 2 illustrates an example structure of a wireless LAN system according to an embodiment of the disclosure;

FIG. 3 illustrates an example of a network structure using an access point (AP) based on Wi-Fi according to an embodiment of the disclosure;

FIG. 4 illustrates an example of a network structure using a direct connection between devices based on Wi-Fi according to an embodiment of the disclosure;

FIG. 5 illustrates an example of a network structure using a direct connection between devices based on Wi-Fi according to an embodiment of the disclosure;

FIG. 6 illustrates an example of a network structure using a direct connection between devices based on Wi-Fi according to an embodiment of the disclosure;

FIG. 7 illustrates an example of a network structure using a direct connection between devices based on Wi-Fi according to an embodiment of disclosure;

FIG. 8 illustrates an example of a network structure using a direct connection between devices based on Wi-Fi according to an embodiment of the disclosure;

FIG. 9 illustrates a process in which an electronic device selects or changes a communication mode according to an embodiment of the disclosure;

FIG. 10 illustrates a process in which an electronic device selects a communication mode and determines a wireless resource allocation scheme according to an embodiment of the disclosure;

FIG. 11 illustrates a process in which an electronic device selects a communication mode and determines a wireless resource allocation scheme during a service according to an embodiment of the disclosure;

FIG. 12 illustrates a comparison between data transmission speeds of communication modes according to an embodiment of the disclosure;

FIG. 13 illustrates a process in which an electronic device selects a communication mode and determines a wireless resource allocation scheme according to an embodiment of the disclosure;

FIG. 14 illustrates a process in which an electronic device selects a communication mode and determines a wireless resource allocation scheme according to an embodiment of the disclosure; and

FIG. 15 illustrates a wireless resource allocation scheme according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the accompanying drawings, some elements may be exaggerated, omitted, or schematically illustrated. Also, the size of each element does not completely reflect the actual size thereof.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operations to be performed on the computer or other programmable apparatus to produce a computer implemented process such that the instructions that execute on the computer or other programmable apparatus provide operations for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the "unit" may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more central processing units (CPUs) within a device or a security multimedia card.

As used herein, in the case where an element is referred to as being "connected," "coupled," or "linked" to any other element, this may cover not only direct connections but also indirect connections in which another element may exist therebetween. As used herein, the expression “include” or “have” are intended to specify the existence of mentioned features, steps, operations, elements, and/or components, but does not preclude the existence or addition of one or more other features, steps, operations, elements, components, and/or combinations thereof.

As used herein, such terms as “a first” and “a second” are used only for the purpose of distinguishing between one element and any other element and not used to limit the elements, and unless mentioned specially, do not limit the order or the importance of the elements. Therefore, a first element in an embodiment may be termed a second element in another embodiment, and similarly, a second element in an embodiment may be termed a first element in another embodiment without departing from the scope of the disclosure.

The terms in the disclosure are used for the sake of describing particular embodiments and are not intended to limit the claims. As used herein, the term "and/or" may refer to one of relevant items enumerated or may refer to and include any or all possible combinations of one or more thereof. In addition, as used herein, the symbol "/" between words has the same meaning as the term "and/or" unless mentioned otherwise.

The examples of the disclosure may be applied to various wireless communication systems. For example, the examples of the disclosure may be applied to a wireless LAN system. For example, the examples of the disclosure may be applied to a wireless LAN system based on IEEE 802.11a/g/n/ac/ax/be standard specifications. Furthermore, the examples of the disclosure may also be applied to a wireless LAN system based on the IEEE 802.11bn (or ultra-high reliability (UHR)) standard specification that is newly discussed. In addition, the examples of the disclosure may also be applied to a next-generation wireless LAN system based on a standard specification after IEEE 802.11bn.

Furthermore, the examples of the disclosure may also be applied to a cellular wireless communication system. For example, the examples of the disclosure may be applied to a cellular wireless communication system based on Long Term Evolution (LTE), LTE advanced (LTE-A), and New Radio (NR) technologies based on 3rd Generation Partnership Project (3GPP) standard specifications.

Hereinafter, various embodiments of the disclosure will be described.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

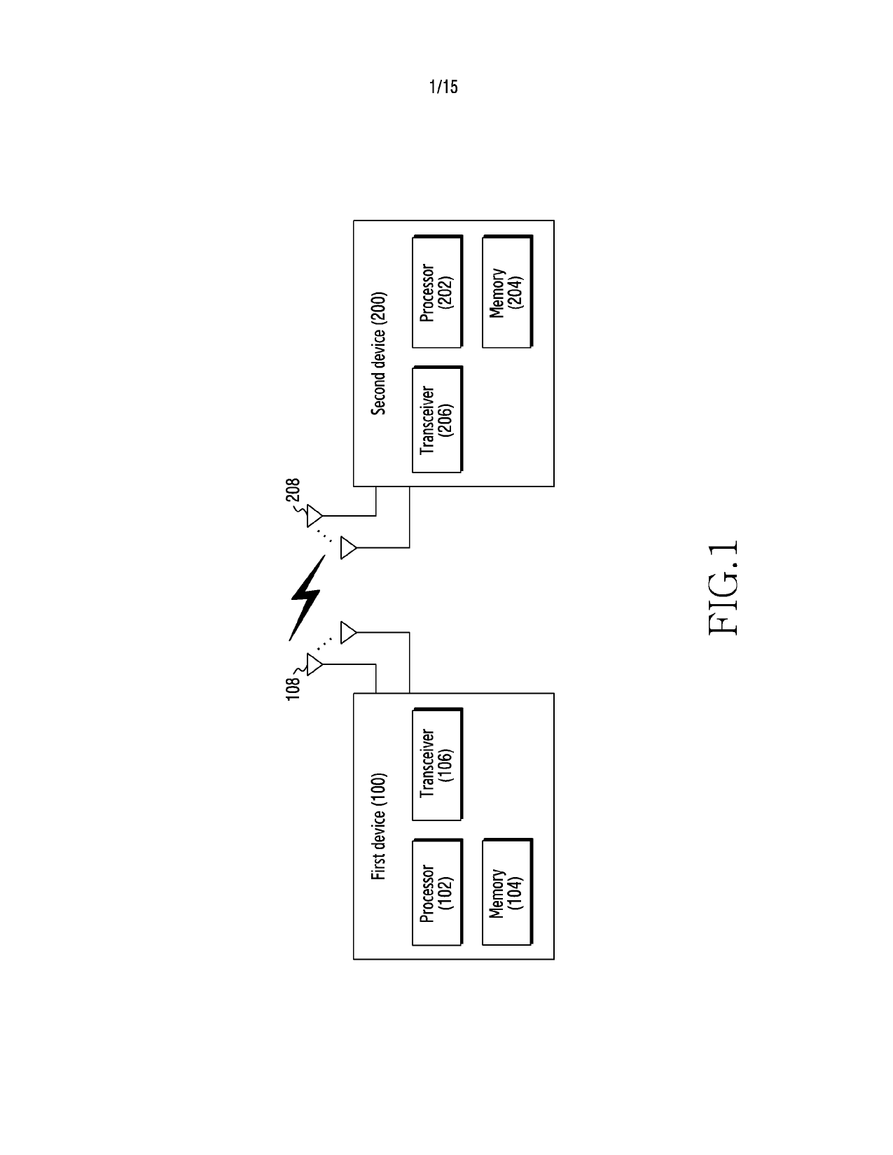

FIG. 1 illustrates a configuration of a device for wireless communication according to an embodiment of the disclosure.

A first device 100 and a second device 200 in FIG. 1 may be replaced with various terms such as a terminal, a wireless device, a wireless transmit and receive unit (WTRU), user equipment (UE), a mobile station (MS), a user terminal (UT), a mobile subscriber station (MSS), a mobile subscriber unit (MSS), a subscriber station (SS), an advanced mobile station (AMS), a wireless terminal (WT), a client terminal, or simply a user.

In addition, the first device 100 and the second device 200 may be replaced with various terms such as an access point (AP), a base station (BS), a fixed station, Node B, a base transceiver system (BTS), a network, an artificial intelligence (AI) system, a road side unit (RSU), a repeater, a router, a relay, or a gateway.

The device 100 or 200 illustrated in FIG. 1 may also be referred to as a station (STA). For example, the device 100 or 200 illustrated in FIG. 1 may be referred to by various terms such as a transmission device, a reception device, a transmission STA, or a reception STA. For example, the STA 100 or 200 may perform an access point (AP) role or a non-AP role. That is, the STA 100 or 200 may perform functions of an AP and/or a non-AP in the disclosure. When the STA 100 or 200 performs an AP function, the STA may simply be referred to as an AP, and when the STA 100 or 200 performs a non-AP function, the STA may simply be referred to as an STA. In addition, in the disclosure, an AP may also be denoted as an AP STA.

Referring to FIG. 1, the first device 100 and the second device 200 may transmit and/or receive a wireless signal through various wireless LAN technologies (e.g., technologies based on IEEE 802.11 standard specifications). The first device 100 and the second device 200 may include an interface for a medium access control (MAC) layer and a physical (PHY) layer that follow rules defined in IEEE 802.11 standard specifications.

In addition, the first device 100 and the second device 200 may additionally support various wireless communication technologies (e.g., technologies based on 3GPP LTE, LTE-A, or NR standard specifications) other than wireless LAN technologies. Furthermore, the device of the disclosure may be implemented as various electronic devices such as a mobile phone, a vehicle, a personal computer, augmented reality (AR) equipment, virtual reality (VR) equipment, or a television (TV). In addition, the STA in the disclosure may support various communication services such as voice calling, video calling, data communication, autonomous driving, machine-type communication (MTC), machine-to-machine (M2M), device-to-device (D2D), and Internet-of-things (IoT).

The first device 100 includes at least one processor 102 and at least one memory 104, and may further include at least one transceiver (or transceiver unit) 106 and/or at least one antenna 108. The processor 102 may be configured to control the memory 104 and/or the transceiver 106, and implement the descriptions, functions, procedures, proposals, methods, and/or operation flowcharts provided in the disclosure. For example, the processor 102 may process information in the memory 104 to generate first information and/or a first signal, and then transmit a wireless signal including the first information and/or the first signal through the transceiver 106. In addition, the processor 102 may receive, through the transceiver 106, a wireless signal including second information and/or a second signal, and then store, in the memory 104, information obtained through signal processing of the second information and/or the second signal. The memory 104 may be connected to the processor 102 and may store various information related to operations of the processor 102. For example, the memory 104 may store software code including instructions for performing some or all of the processes controlled by the processor 102, or for performing the descriptions, functions, procedures, proposals, methods, and/or operation flowcharts provided in the disclosure. Here, the processor 102 and the memory 104 may be part of a communication modem/circuit/chip designed to implement wireless LAN technologies (e.g., technologies based on IEEE 802.11 specifications). The transceiver 106 may be connected to the processor 102 and may transmit and/or receive a wireless signal through the at least one antenna 108. The transceiver 106 may include a transmitter and/or a receiver. The transceiver 106 may be used interchangeably with a radio frequency (RF) unit.

The second device 200 includes at least one processor 202 and at least one memory 204, and may further include at least one transceiver (or transceiver unit) 206 and/or at least one antenna 208. The processor 202 may be configured to control the memory 204 and/or the transceiver 206, and implement the descriptions, functions, procedures, proposals, methods, and/or operation flowcharts provided in the disclosure. For example, the processor 202 may process information in the memory 204 to generate third information and/or a third signal, and then transmit a wireless signal including the third information and/or the third signal through the transceiver 206. In addition, the processor 202 may receive, through the transceiver 206, a wireless signal including fourth information and/or a fourth signal, and then store, in the memory 204, information obtained through signal processing of the fourth information and/or the fourth signal. The memory 204 may be connected to the processor 202 and may store various information related to operations of the processor 202. For example, the memory 204 may store software code including instructions for performing some or all of the processes controlled by the processor 202, or for performing the descriptions, functions, procedures, proposals, methods, and/or operation flowcharts provided in the disclosure. Here, the processor 202 and the memory 204 may be part of a communication modem/circuit/chip designed to implement wireless LAN technologies (e.g., technologies based on IEEE 802.11 specifications). The transceiver 206 may be connected to the processor 202 and may transmit and/or receive a wireless signal through the at least one antenna 208. The transceiver 206 may include a transmitter and/or a receiver. The transceiver 206 may be used interchangeably with an RF unit.

Hereinafter, hardware elements of the device 100 or 200 will be described in more detail. Although not limited to the following description, operations of at least one protocol layer may be implemented by at least one processor 102 or 202. For example, the at least one processor 102 or 202 may implement operations of at least one layer (e.g., a functional layer such as a PHY or a MAC). The at least one processor 102 or 202 may generate at least one protocol data unit (PDU) and/or at least one service data unit (SDU) according to the descriptions, functions, procedures, proposals, methods, and/or operation flowcharts provided in the disclosure. The at least one processor 102 or 202 may generate a message, control information, data, or information according to the descriptions, functions, procedures, proposals, methods, and/or operation flowcharts provided in the disclosure. The at least one processor 102 or 202 may generate a signal (e.g., a baseband signal) including a PDU, an SDU, a message, control information, data, traffic, or information according to the functions, procedures, proposals, and/or methods provided in the disclosure, and may provide the generated signal to at least one transceiver 106 or 206. The at least one processor 102 or 202 may receive a signal (e.g., a baseband signal) from the at least one transceiver 106 or 206, and may obtain a PDU, an SDU, a message, control information, data, traffic, or information according to the descriptions, functions, procedures, proposals, methods, and/or operation flowcharts provided in the disclosure.

At least one memory 104 or 204 may be connected to the at least one processor 102 or 202 and may store various types of data, signals, messages, information, programs, code, indications, and/or instructions. The at least one memory 104 or 204 may be configured as read only memory (ROM), random access memory (RAM), erasable programmable ROM (EPROM), electronically EPROM (EEPROM), flash memory, a hard drive, a register, cache memory, a computer-readable storage medium, and/or a combination thereof. The at least one memory 104 or 204 may be located inside and/or outside the at least one processor 102 or 202. In addition, the at least one memory 104 or 204 may be connected to the at least one processor 102 or 202 through various technologies such as wired or wireless connections.

At least one transceiver 106 or 206 may transmit, to at least one other device, user data, control information, data, traffic, a wireless signal, and/or a channel mentioned in the methods and/or operation flowcharts provided in the disclosure. The at least one transceiver 106 or 206 may receive, from at least one other device, user data, control information, data, traffic, a wireless signal, and/or a channel mentioned in the descriptions, functions, procedures, proposals, methods, and/or operation flowcharts provided in the disclosure. For example, the at least one transceiver 106 or 206 may be connected to the at least one processor 102 or 202 and may transmit and receive a wireless signal. For example, the at least one processor 102 or 202 may control the at least one transceiver 106 or 206 to transmit user data, control information, traffic, a wireless signal, and/or a channel to at least one other device. In addition, the at least one processor 102 or 202 may control the at least one transceiver 106 or 206 to receive user data, control information, traffic, a wireless signal, and/or a channel from at least one other device. In addition, the at least one transceiver 106 or 206 may be connected to at least one antenna 108 or 208, and the at least one transceiver 106 or 206 may be configured to transmit and receive, through the at least one antenna 108 or 208, user data, control information, traffic, a wireless signal, and/or a channel mentioned in the descriptions, functions, procedures, proposals, methods, and/or operation flowcharts provided in the disclosure. In the disclosure, the at least one antenna 108 or 208 may be a plurality of physical antennas or a plurality of logical antennas (e.g., antenna ports). The at least one transceiver 106 or 206 may, in order to process received user data, control information, or wireless signal/channel by using the at least one processor 102 or 202, convert the received wireless signal/channel from an RF-band signal into a baseband signal. The at least one transceiver 106 or 206 may convert user data, control information, or a wireless signal/channel, which has been processed using the at least one processor 102 or 202, from a baseband signal into an RF-band signal. To this end, the at least one transceiver 106 or 206 may include an (analog) oscillator and/or a filter.

According to an example, one of the devices 100 and 200 may perform an intended operation of an AP, and the other one of the devices 100 and 200 may perform an intended operation of a non-AP STA. In another example, the transceiver 106 or 206 of FIG. 1 may perform an operation of transmitting and/or receiving a signal (e.g., a packet or a physical layer protocol data unit (PPDU) according to IEEE 802.11a/b/g/n/ac/ax/be/bn).

In addition, in the disclosure, an operation of generating, by various STAs, a transmission or reception signal or performing data processing or computation in advance for the transmission or reception signal may be performed by the processor 102 or 202 of FIG. 1. For example, an example of the operation of generating a transmission or reception signal or performing data processing or computation in advance for the transmission or reception signal may include (1) an operation of determining/acquiring/configuring/computing/decoding/encoding bit information of a field (e.g., signal (SIG), short training field (STF), long training field (LTF), or Data) included in a PPDU, (2) an operation of determining/configuring/acquiring a time resource or a frequency resource (e.g., a subcarrier resource) used for a field (e.g., SIG, STF, LTF, or Data) included in a PPDU, (3) an operation of determining/configuring/acquiring a particular sequence (e.g., a pilot sequence, an STF/LTF sequence, or an extra sequence applied to SIG) used for a field (e.g., SIG, STF, LTF, or Data) included in a PPDU, (4) a power saving operation and/or a power control operation applied to an STA, and (5) an operation related to determining/acquiring/configuring/computing/decoding/encoding an acknowledgement (ACK) signal. In addition, in the following examples, various information (e.g., information related to a field/subfield/control field/parameter/power) used by various STAs to determine/acquire/configure/compute/decode/encode a transmission or reception signal may be stored in the memory 104 or 204 of FIG. 1.

Hereinafter, a downlink (DL) refers to a link for communication from an AP STA to a non-AP STA, and a downlink PPDU/packet/signal may be transmitted or received through the downlink. In downlink communication, a transmitter may be part of the AP STA, and a receiver may be part of the non-AP STA. An uplink (UL) refers to a link for communication from a non-AP STA to an AP STA, and an uplink PPDU/packet/signal may be transmitted or received through the uplink. In uplink communication, a transmitter may be part of the non-AP STA, and a receiver may be part of the AP STA.

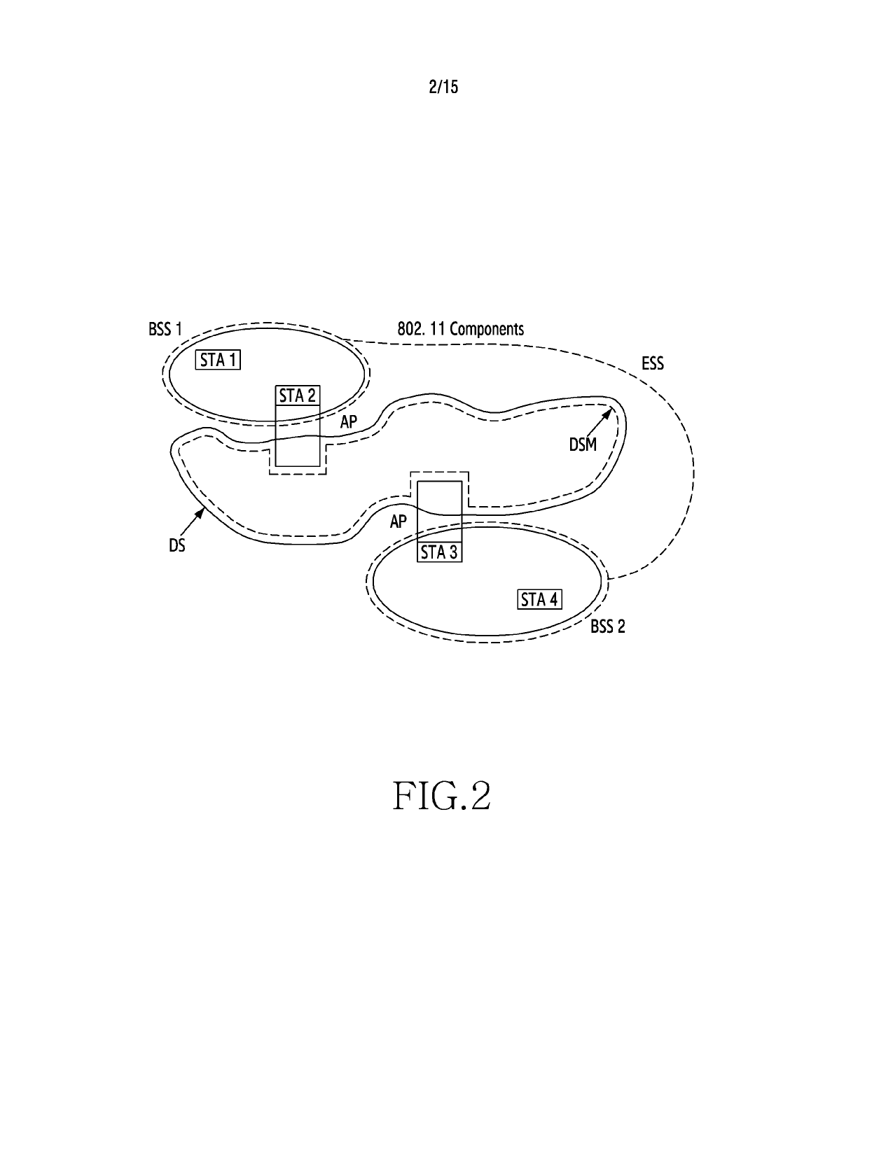

FIG. 2 illustrates an example structure of a wireless LAN system according to an embodiment of the disclosure.

A wireless LAN system may have a structure configured by multiple components. The wireless LAN system may support STA mobility that is transparent to an upper layer through interactions between the multiple components. A basic service set (BSS) corresponds to a fundamental configuration block of a wireless LAN. FIG. 2 illustrates an example in which two BSSs (BSS 1 and BSS 2) exist, and that two STAs are included as members of each BSS (STA 1 and STA 2 are included in BSS 1, and STA 3 and STA 4 are included in BSS 2). In FIG. 2, an ellipse representing a BSS may also be understood as indicating a coverage area in which STAs included in the corresponding BSS maintain communication. This area may be referred to as a basic service area (BSA). When an STA moves outside the BSA, the STA is unable to directly communicate with other STAs within the corresponding BSA.

If a distributed system (DS) illustrated in FIG. 2 is not considered, the most basic type of a BSS in a wireless LAN is an independent BSS (IBSS). For example, an IBSS may have a minimum form configured by only two STAs. For example, assuming that other components are omitted, BSS 1 configured by only STA 1 and STA 2 or BSS 2 configured by only STA 3 and STA 4 may each correspond to representative examples of an IBSS. Such a configuration is possible when STAs are able to directly communicate without an AP. In addition, this type of wireless LAN may be configured when a local area network (LAN) is needed, rather than being pre-planned, and may also be referred to as an ad-hoc network. Because an IBSS does not include an AP, there is no entity (centralized management entity) that performs centralized management functions. That is, in an IBSS, STAs are managed in a distributed manner. In an IBSS, all STAs may be mobile STAs, and access to the DS is not allowed, thereby forming a self-contained network.

The membership of an STA in a BSS may be dynamically changed due to an STA being turned on or off, or an STA entering or leaving a BSS area. To become a member of a BSS, an STA may join the BSS by using a synchronization process. To access all services of a BSS-based structure, an STA needs to be associated with the BSS. Such association may be dynamically configured and may include the use of a distribution system service (DSS).

In a wireless LAN, a direct STA-to-STA distance may be limited by PHY performance. In some cases, such a distance limitation may be sufficient, but in other cases, communication between STAs over a longer distance may be required. To support extended coverage, a DS may be configured.

A DS refers to a structure by which BSSs are interconnected. Specifically, as illustrated in FIG. 2, a BSS may exist as a component of an extended network configured by multiple BSSs. A DS is a logical concept and may be specified by properties of a distributed system (DS) medium (DSM). In this regard, a wireless medium (WM) and the DSM may be logically distinguished. Each logical medium is used for a different purpose and is used by a different component. These media are neither limited to being identical nor limited to being different. Because such multiple media are logically different from each other, the flexibility of a wireless LAN structure (a DS structure or another network structure) may be described. That is, a wireless LAN structure may be variously implemented, and the wireless LAN structure may be independently specified by physical properties of each implementation example.

A DS may support mobile devices by providing seamless integration of multiple BSSs and by offering logical services required to handle addressing to a destination. In addition, a DS may further include, as a component, a portal which serves as a bridge for connecting a wireless LAN to another network (e.g., IEEE 802.X).

An AP enables non-AP STAs associated with the AP to access to a DS through a WM. An AP may refer to an entity that also has STA functionality, and data movement between a BSS and a DS may be performed through the AP. For example, STA 2 and STA 3 as illustrated in FIG. 2, have STA functionality and provide a function that enables the associated non-AP STAs (STA 1 and STA 4) to access the DS. In addition, because every AP fundamentally corresponds to an STA, every AP is an addressable entity. An address used by an AP for communication over a WM and an address used by the AP for communication over a DSM do not necessarily need to be identical. A BSS configured by an AP and one or more STAs may be referred to as an infrastructure BSS.

Data transmitted from one of the STAs associated with an AP to the STA address of the AP is always received at an uncontrolled port and may be processed by an IEEE 802.1X port access entity. In addition, when a controlled port is authenticated, the transmitted data (or frame) may be delivered to a DS.

An extended service set (ESS) may be configured to additionally provide a wider coverage to the aforementioned DS structure.

An ESS is a network of arbitrary size and complexity, and may correspond to a set of BSSs connected to a DS. However, an ESS does not include the DS. An ESS network has a feature of appearing as an IBSS at the logical link control (LLC) layer. STAs included in an ESS may communicate with one another, and mobile STAs may move from one BSS to another BSS (i.e., within the same ESS) in a manner transparent to the LLC. APs included in an ESS may have the same service set identifier (SSID). The SSID is distinguished from a BSSID (BSS SSID), which is an identifier of a BSS.

A wireless LAN system does not assume anything about the relative physical locations of BSSs, and the following forms are all possible. BSSs may be partially overlapped, which is a form commonly used to provide continuous coverage. BSSs may also not be physically connected, and there is no logical limitation on the distance between BSSs. In addition, BSSs may be physically located in the same position, which may be used to provide redundancy. Furthermore, one or more IBSS or ESS networks may physically exist in the same space as one (or one or more) ESS networks. This may correspond to forms of ESS networks in a case where an ad-hoc network operates in a location where an ESS network exists, a case where physically overlapped wireless networks are configured by different organizations, or a case where two or more different access and security policies are required in the same location.

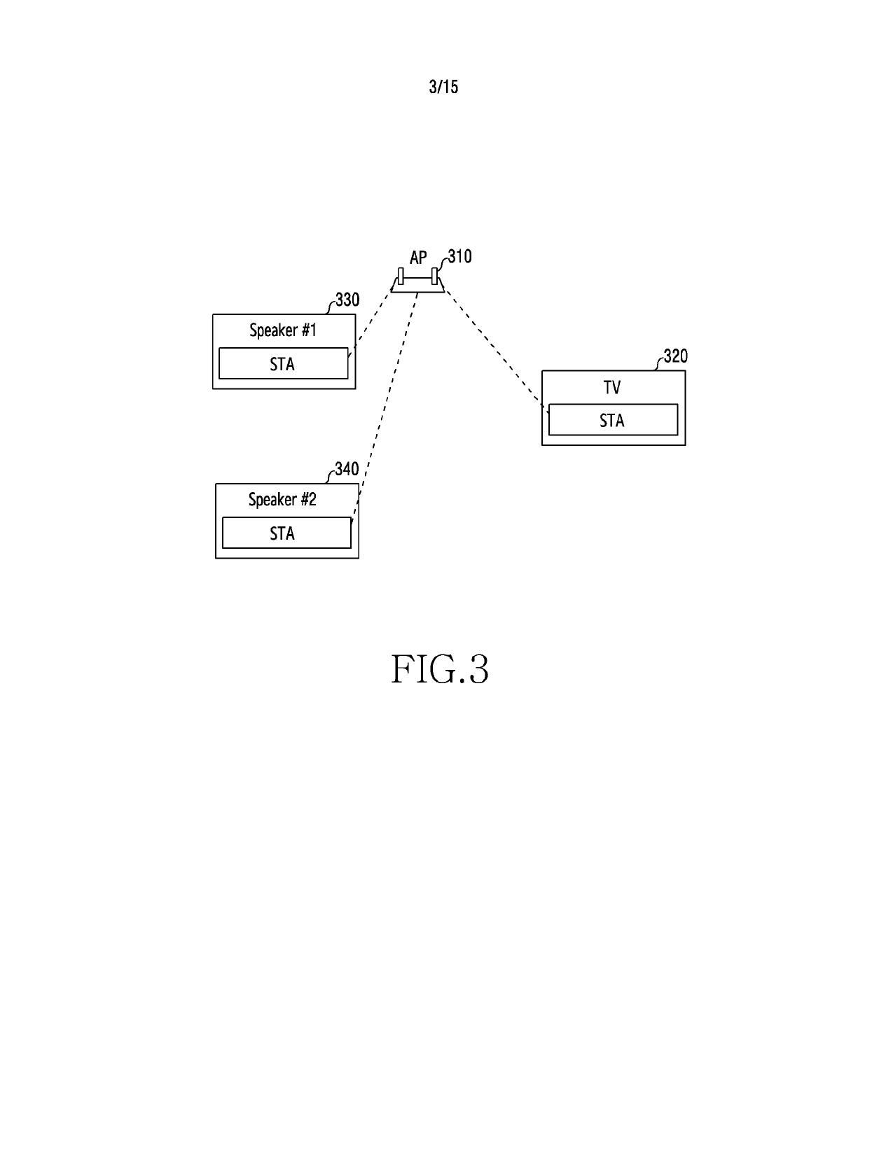

FIG. 3 illustrates an example of a network structure using an access point (AP) based on Wi-Fi in a wireless LAN system according to an embodiment of the disclosure.

Referring to FIG. 3, a connection between an AP 310 and electronic devices 320, 330, and 340 (e.g., a speaker, a TV, and the like) is illustrated. Specifically, the AP 310 may be connected to each of a first speaker 330, a second speaker 340, and a TV 320. The AP 310 may, as a central manager for configuring a network, be connected to each of the electronic devices, and the electronic devices connected to the AP 310 may transmit or receive service data to each other. Therefore, based on such a network structure, the first speaker 330 and the second speaker 340 may be connected to the TV 320, and the first speaker 330 and the second speaker 340 may reproduce audio data received from the TV 320 through the AP 310. Each of the first speaker 330, the second speaker 340, and the TV 320 may include a communication module (e.g., a STA module) for supporting a network in which it is possible to transmit or receive data between devices by using the AP 310 as a central manager. The STA module may refer to a communication module for supporting a connection between devices through a wireless access point and a central manager. For supporting the network connections illustrated in FIG. 3, each of the electronic device 320, 330, and 340 may include the STA module. The STA module may refer to circuitry or software configured in a processor or a chipset included in each of the electronic devices. In addition, a name of the communication module is not limited to terms described in the disclosure and may be referred to using various terms.

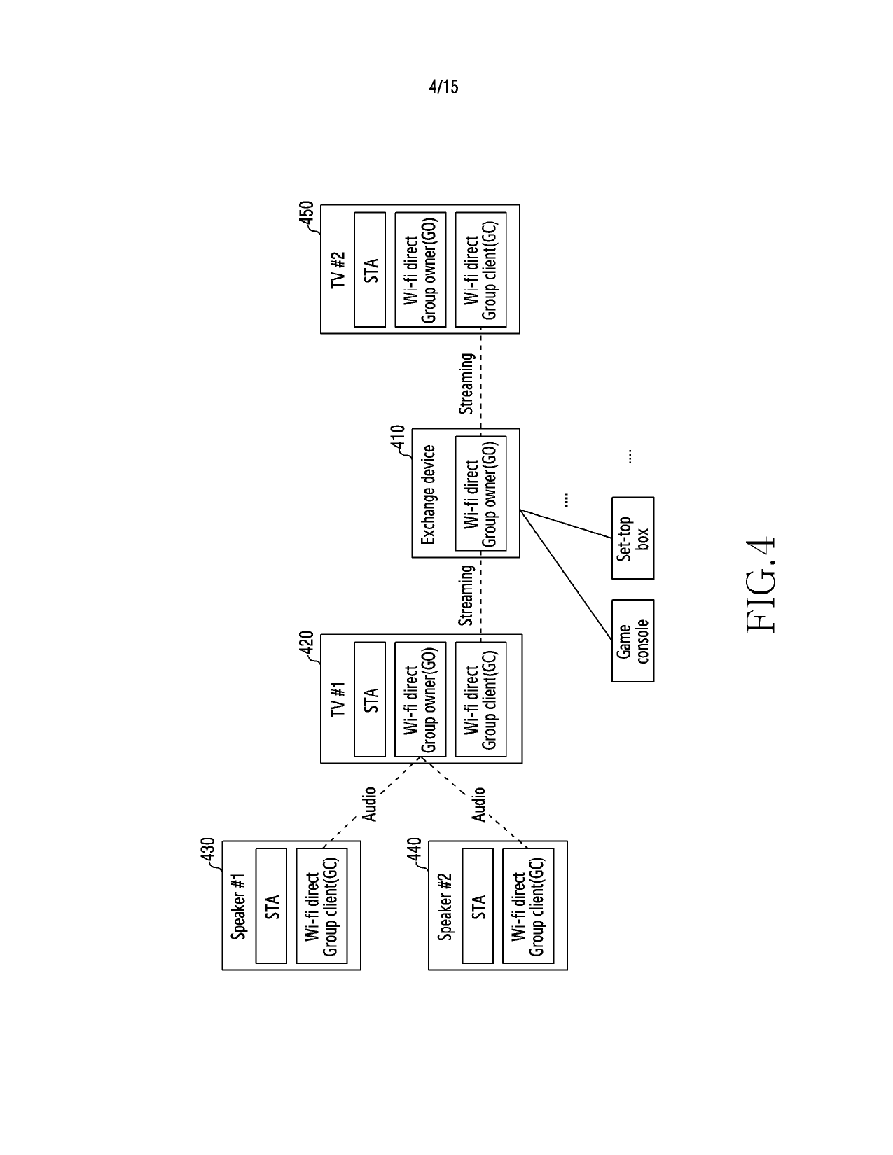

FIG. 4 illustrates an example of a network structure using a direct connection between devices based on Wi-Fi in a wireless LAN system according to an embodiment of the disclosure.

Referring to FIG. 4, illustrated is a state in which a direct wireless connection between devices is established for an audio service between a first TV 420 and a first speaker 430 and between the first TV 420 and a second speaker 440, and a direct connection between devices is established for a streaming service between the first TV 420 and an exchange device 410 and between a second TV 450 and the exchange device 410.

The exchange device 410 may be connected to another electronic device such as a game console or a set-top box through a wired or wireless connection, and may wirelessly transmit service data received from the connected electronic device to the first TV 420 and/or the second TV 450. The exchange device 410 may simultaneously transmit the service data to the first TV 420 and the second TV 450. Specifically, the exchange device 410 may receive service data for a streaming service from the set-top box and transmit the received service data to the first TV 420 and/or the second TV 450. In addition, the exchange device 410 transmits service data for a streaming service received from the set-top box to the first TV 420, and simultaneously transmit service data for a game service received from the game console to the second TV 450. A type of an input source device capable of transmitting service data to the exchange device 410 is not limited to the types illustrated in FIG. 4. That is, the exchange device 410 may transmit respective pieces of service data received from various input source devices to multiple output devices.

In FIG. 4, a connection between electronic devices may indicate a direct connection between devices through a central manager without a wireless access point. That is, the connection may indicate wireless communication based on Wi-Fi direct. In wireless communication based on Wi-Fi direct, one of nodes configuring a network performs a role of a central manager as a group owner, and the remaining nodes may perform one-to-one communication with the group owner as group clients.

Specifically, in FIG. 4, the first TV 420 is a group owner, and the first speaker 430 and the second speaker 440 may be group clients. Therefore, the first speaker 430 and the second speaker 440 may be connected to the first TV 420 to directly receive audio data from the first TV 420 and reproduce the received audio data. As described above, a method in which the speaker directly receives audio data from the TV and reproduces same may be efficient compared to a method in which service data is relayed through a wireless access point (AP).

In addition, in FIG. 4, the exchange device 410 is a group owner, and the first TV 420 and the second TV 450 may be group clients. Therefore, the first TV 420 and the second TV 450 may directly receive service data for streaming from the exchange device 410, and may reproduce the received service data. For example, the first TV 420 may receive service data for streaming from the exchange device 410 and reproduce the received service data. Simultaneously, the second TV 450 may receive service data for streaming from the exchange device 410 and reproduce the received service data.

For an operation based on the network structure of FIG. 4, each of the first speaker 430 and the second speaker 440 may include a communication module for supporting a direct connection between devices through a central manager without a wireless access point. Specifically, each of the first speaker 430 and the second speaker 440 may include a communication module for supporting a group client in wireless communication based on Wi-Fi direct. The exchange device 410 may include a communication module for supporting a group owner in wireless communication based on Wi-Fi direct. The exchange device 410 may function as a group owner, that is, a central manager node of a network.

For an operation based on the network structure of FIG. 4, the first TV 420 may operate as a group client in a connection with the exchange device 410, and may operate as a group owner in a connection with the first speaker 430 and the second speaker 440. That is, the first TV 420 may include a first communication module for supporting a group client in wireless communication based on Wi-Fi direct and a second communication module for supporting a group owner together. At this time, the first communication module and the second communication module are configured in one chipset (or processor) or are configured in multiple separate chipsets, respectively.

The first TV 420 may transmit service data for audio to the first speaker 430 and the second speaker 440 while reproducing service data for streaming received from the exchange device 410, and the first speaker 430 and the second speaker 440 reproduce the service data received from the first TV 420. That is, from a perspective of a user, a streaming service and an audio service may be satisfied simultaneously.

In various embodiments, the first TV 420 may receive service data delivered through the set-top box from the exchange device 410 and reproduce the received service data. At the same time, the second TV 450 may receive service data delivered through the game console from the exchange device 410 and reproduce the received service data. That is, the exchange device 410 may transmit different pieces of service data to multiple TVs, respectively.

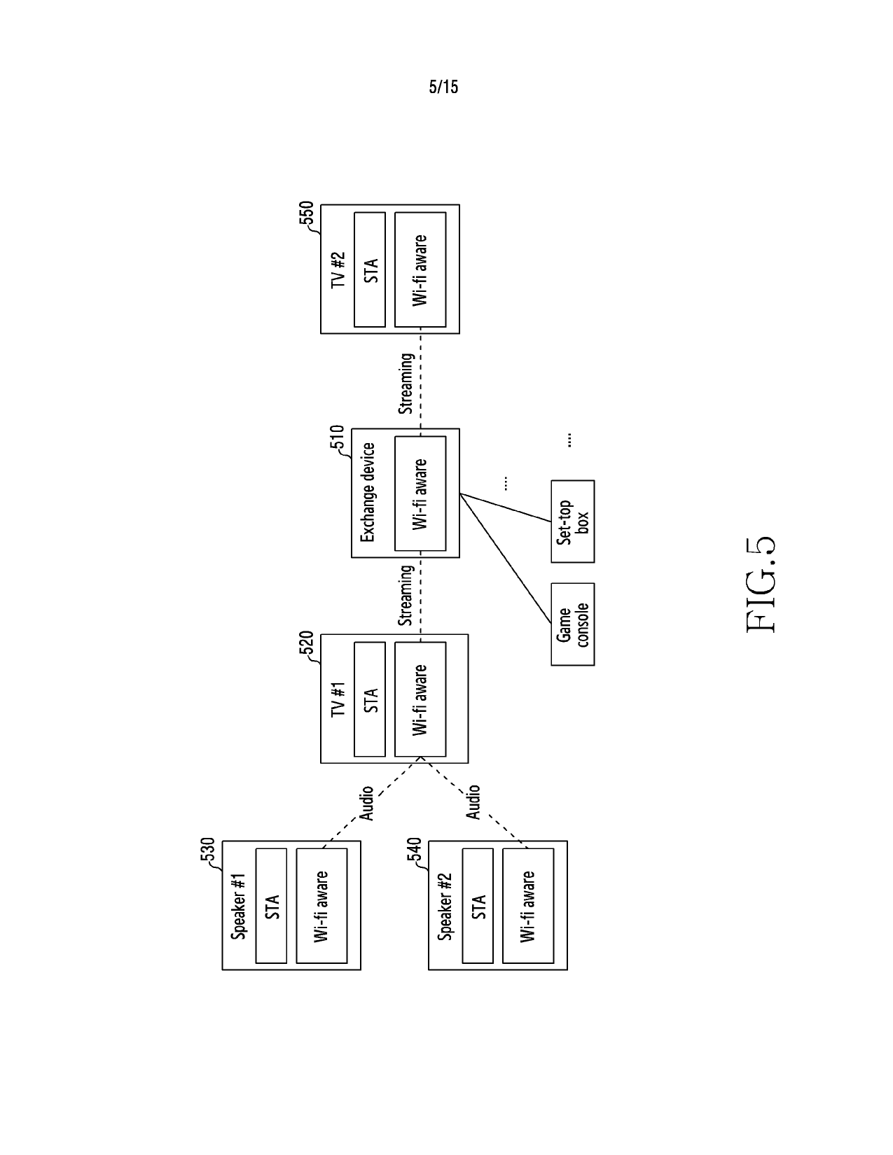

FIG. 5 illustrates an example of a network structure using a direct connection between devices based on Wi-Fi in a wireless LAN system according to an embodiment of the disclosure.

Referring to FIG. 5, illustrated is a state in which a direct wireless connection between devices is established for an audio service between a first TV 520 and a first speaker 530 and between the first TV 520 and a second speaker 540, and a direct connection between devices is established for a streaming service between the first TV 520 and an exchange device 510 and between a second TV 550 and the exchange device 510. The exchange device 510 may be connected to another electronic device such as a game console or a set-top box through a wired or wireless connection, and may wirelessly transmit service data received from the connected electronic device to the first TV 520 and/or the second TV 550. The exchange device 510 may simultaneously transmit the service data to the first TV 520 and the second TV 550.

In FIG. 5, a connection between electronic devices may indicate a direct connection between devices in a distributed manner without a wireless access point and a central manager. That is, the connection may indicate wireless communication based on Wi-Fi aware. In wireless communication based on Wi-Fi aware, nodes configuring a network may each search for another adjacent node and establish a connection with the found node so as to perform one-to-one communication. In communication based on Wi-Fi aware, each node may transmit a Wi-Fi beacon signal (or frame). In addition, in communication based on Wi-Fi aware, each node may identify a presence or absence of an adjacent node through a Wi-Fi beacon signal (or frame) transmitted from the adjacent node.

Specifically, each of the first speaker 530 and the second speaker 540 may be connected to the first TV 520 to directly receive audio data from the first TV 520 and reproduce the received audio data. As described above, a method in which the speaker directly receives audio data from the TV and reproduces same may be efficient compared to a method in which service data is relayed through a wireless access point.

In addition, the first TV 520 and the second TV 550 may directly receive service data for streaming from the exchange device 510, and may reproduce the received service data. For example, the first TV 520 may receive service data for streaming from the exchange device 510 and reproduce the received service data. Simultaneously, the second TV 550 may receive service data for streaming from the exchange device 510 and reproduce the received service data.

For an operation based on the network structure of FIG. 5, each of the first speaker 530 and the second speaker 540 may include a communication module for supporting a direct connection between devices in a distributed manner without a wireless access point and a central manager. Specifically, each of the first speaker 530 and the second speaker 540 may include a communication module for supporting wireless communication based on Wi-Fi aware. The exchange device 510 may include a communication module for supporting wireless communication based on Wi-Fi aware. A one-to-one connection is established between the electronic devices each including a communication module for supporting wireless communication based on Wi-Fi aware, and service data between the devices may be transmitted or received.

In addition, for an operation based on the network structure of FIG. 5, the first TV 520 may include a communication module for supporting wireless communication based on Wi-Fi aware. The first TV 520 may transmit service data for audio to the first speaker 530 and the second speaker 540 while reproducing service data for streaming received from the exchange device 510, and the first speaker 530 and the second speaker 540 reproduce the service data received from the first TV 520. That is, from a perspective of a user, a streaming service and an audio service may be satisfied simultaneously.

In various embodiments, the first TV 520 may receive service data delivered through the set-top box from the exchange device 510 and reproduce the received service data. At the same time, the second TV 550 may receive service data delivered through the game console from the exchange device 510 and reproduce the received service data. That is, the exchange device may transmit different pieces of service data to multiple TVs, respectively.

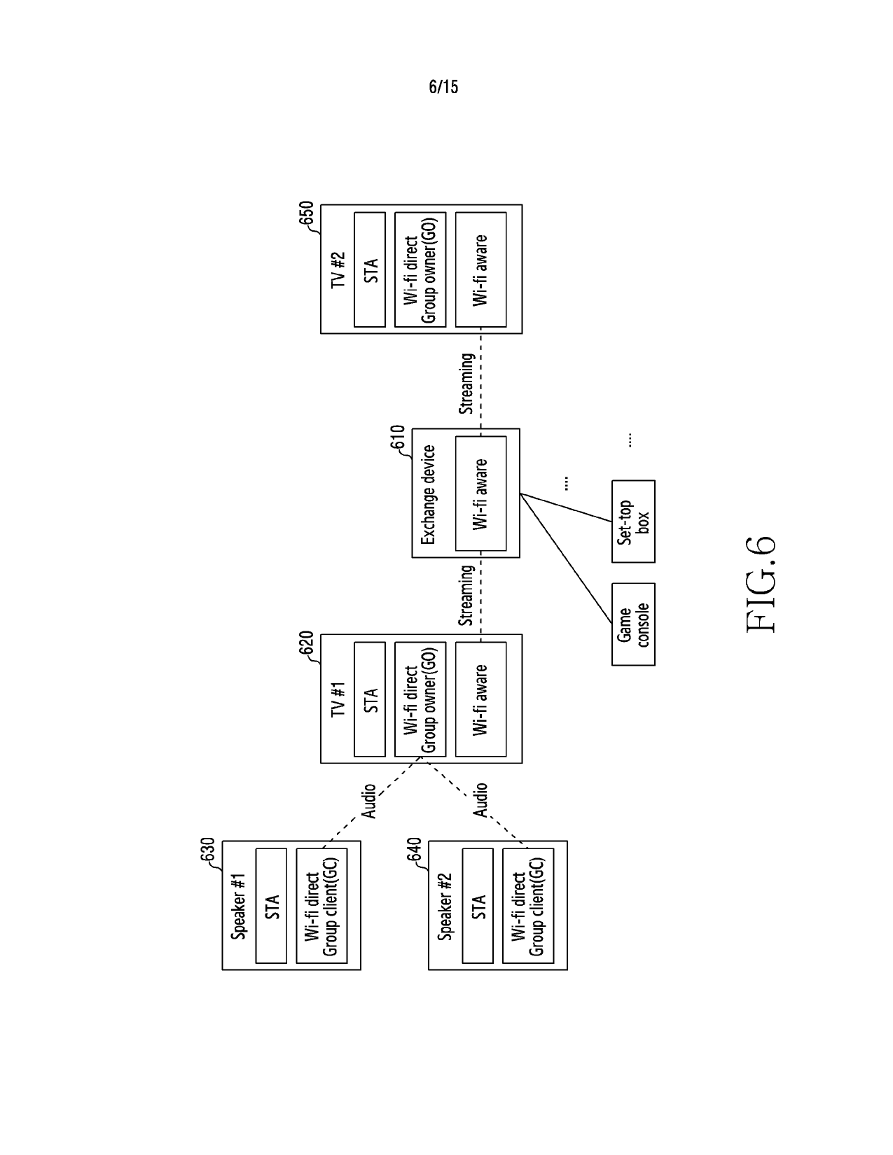

FIG. 6 illustrates an example of a network structure using a direct connection between devices based on Wi-Fi in a wireless LAN system according to an embodiment of the disclosure.

Referring to FIG. 6, illustrated is a state in which a direct wireless connection between devices is established for an audio service between a first TV 620 and a first speaker 630 and between the first TV 620 and a second speaker 640, and a direct connection between devices is established for a streaming service between the first TV 620 and an exchange device 610 and between a second TV 650 and the exchange device 610. The exchange device 610 may be connected to another electronic device such as a game console or a set-top box through a wired or wireless connection, and may wirelessly transmit service data received from the connected electronic device to the first TV 620 and/or the second TV 650. The exchange device 610 may simultaneously transmit the service data to the first TV 620 and the second TV 650.

For an operation based on the network structure of FIG. 6, each of the first TV 620, the first speaker 630, and the second speaker 640 may include a communication module (a Wi-Fi direct support module) for supporting a direct connection between devices through a central manager without a wireless access point. Specifically, each of the first speaker 630 and the second speaker 640 may include a communication module for supporting a group client in wireless communication based on Wi-Fi direct. In addition, the first TV 620 may include a communication module for supporting a group owner in wireless communication based on Wi-Fi direct. Each of the exchange device 610, the first TV 620, and the second TV 650 may include a communication module (a Wi-Fi aware support module) for supporting a direct connection between devices in a distributed manner without a wireless access point and a central manager. That is, each of the exchange device 610, the first TV 620, and the second TV 650 may include a communication module for supporting a direct connection between devices in wireless communication based on Wi-Fi aware.

In FIG. 6, a connection between the first speaker 630 and the second speaker 640, and the first TV 620 may indicate a direct connection between devices through a central manager without a wireless access point. That is, a connection between the first speaker 630 and the second speaker 640, and the first TV 620 may indicate wireless communication based on Wi-Fi direct. In wireless communication based on Wi-Fi direct, one of nodes configuring a network performs a role of a central manager as a group owner, and the remaining nodes may perform one-to-one communication with the group owner as group clients.

Specifically, in FIG. 6, the first TV 620 is a group owner, and the first speaker 630 and the second speaker 640 may be group clients. Therefore, the first speaker 630 and the second speaker 640 may be connected to the first TV 620 to directly receive audio data from the first TV 620 and reproduce the received audio data. As described above, a method in which the speaker directly receives audio data from the TV and reproduces same may be efficient compared to a method in which service data is relayed through a wireless access point.

In addition, in FIG. 6, a connection between the exchange device 610 and the first TV 620 and the second TV 650 may indicate a direct connection between devices in a distributed manner without a wireless access point and a central manager. That is, a connection between the exchange device 610 and the first TV 620 and the second TV 650 may be a wireless communication connection based on Wi-Fi aware. In wireless communication based on Wi-Fi aware, nodes configuring a network may each search for another adjacent node and establish a connection with the found node so as to perform one-to-one communication. In communication based on Wi-Fi aware, each node may transmit a Wi-Fi beacon signal (or frame). In addition, in communication based on Wi-Fi aware, each node may identify a presence or absence of an adjacent node through a Wi-Fi beacon signal (or frame) transmitted from the adjacent node.

Each of the first TV 620, the second TV 650, and the exchange device 610 may include a communication module for supporting wireless communication based on Wi-Fi aware, and a one-to-one connection is established between the electronic devices for supporting wireless communication based on Wi-Fi aware so as to enable service data to be transmitted or received. Specifically, the first TV 620 and the second TV 650 may directly receive service data for streaming from the exchange device 610, and may reproduce the received service data. For example, the first TV 620 may receive service data for streaming from the exchange device 610 and reproduce the received service data. Simultaneously, the second TV 650 may receive service data for streaming from the exchange device 610 and reproduce the received service data.

For an operation based on the network structure of FIG. 6, the first TV 620 may perform communication based on Wi-Fi aware with the exchange device 610, and may operate as a group owner in communication based on Wi-Fi direct with the first speaker 630 and the second speaker 640. That is, the first TV 620 may include both a first communication module for supporting a group owner in wireless communication based on Wi-Fi direct and a second communication module for supporting wireless communication based on Wi-Fi aware. At this time, the first communication module and the second communication module are configured in one chipset or are configured in multiple separate chipsets, respectively. The first TV 620 may transmit service data for audio to the first speaker 630 and the second speaker 640 while reproducing service data for streaming received from the exchange device 610, and the first speaker 630 and the second speaker 640 reproduce the service data received from the first TV 620. From a perspective of a user, a streaming service and an audio service may be satisfied simultaneously.

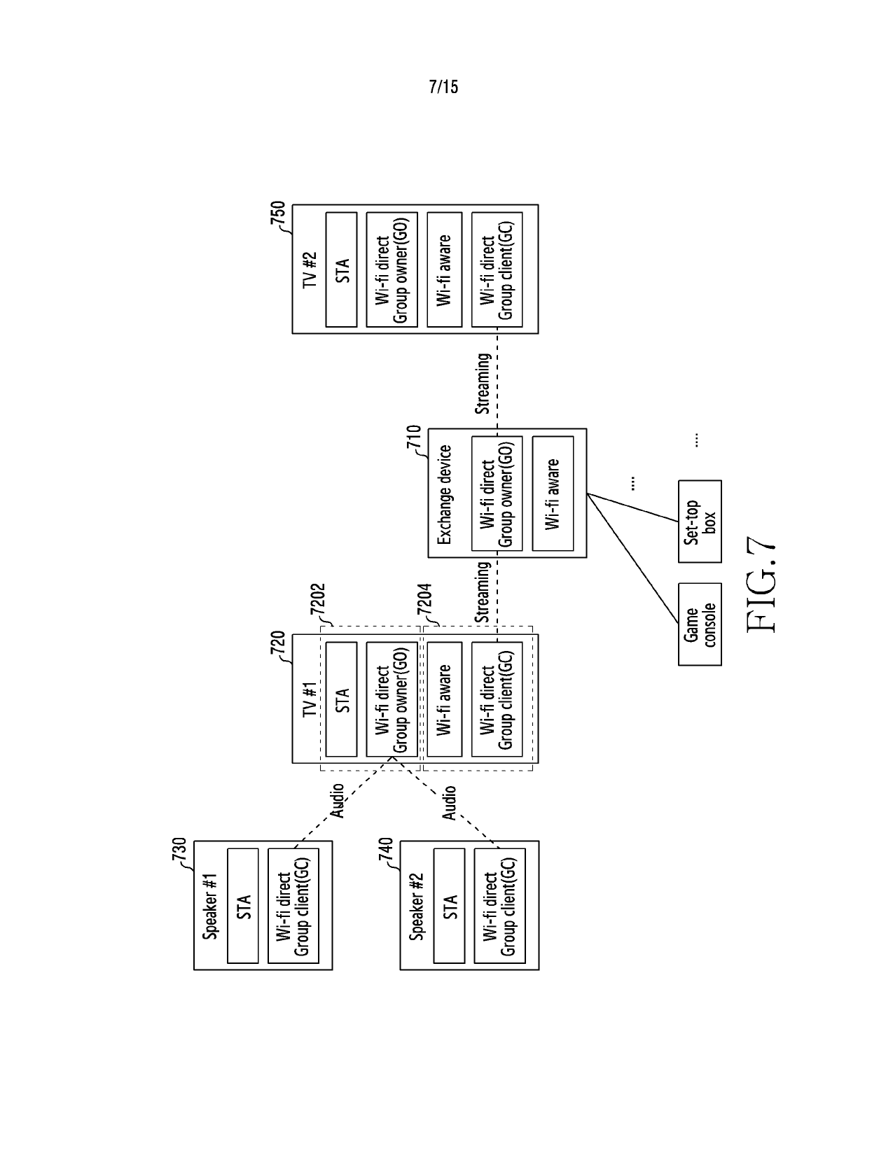

FIG. 7 illustrates an example of a network structure using a direct connection between devices based on Wi-Fi in a wireless LAN system according to an embodiment of the disclosure.

Referring to FIG. 7, illustrated is a state in which a direct wireless connection between devices is established for an audio service between a first TV 720 and a first speaker 730 and between the first TV 720 and a second speaker 740, and a direct connection between devices is established for a streaming service between the first TV 720 and an exchange device 710 and between a second TV 750 and the exchange device 710. The exchange device 710 may be connected to another electronic device such as a game console or a set-top box through a wired or wireless connection, and may wirelessly transmit service data received from the connected electronic device to the first TV 720 and/or the second TV 750. The exchange device 710 may simultaneously transmit the service data to the first TV 720 and the second TV 750.

For an operation based on the network structure of FIG. 7, each of the first TV 720, the first speaker 730, and the second speaker 740 may include a communication module for supporting a direct connection between devices through a central manager without a wireless access point. Specifically, each of the first speaker 730 and the second speaker 740 may include a communication module for supporting a group client in wireless communication based on Wi-Fi direct. In addition, the first TV 720 may include a first communication module for supporting a group owner in wireless communication based on Wi-Fi direct and a second communication module for supporting a group client together. Each of the exchange device 710, the first TV 720, and the second TV 750 may include a third communication module for supporting a direct connection between devices in a distributed manner without a wireless access point and a central manager. That is, each of the exchange device 710, the first TV 720, and the second TV 750 may include a communication module for supporting a direct connection between devices in wireless communication based on Wi-Fi aware.

In FIG. 7, a connection between the first speaker 730 and the second speaker 740, and the first TV 720 may indicate a direct connection between devices through a central manager without a wireless access point. That is, a connection between the first speaker 730 and the second speaker 740, and the first TV 720 may indicate wireless communication based on Wi-Fi direct. In wireless communication based on Wi-Fi direct, one of nodes configuring a network performs a role of a central manager as a group owner, and the remaining nodes may perform one-to-one communication with the group owner as group clients.

Specifically, in FIG. 7, the first TV 720 is a group owner, and the first speaker 730 and the second speaker 740 may be group clients. Therefore, the first speaker 730 and the second speaker 740 may be connected to the first TV 720 to directly receive audio data from the first TV 720 and reproduce the received audio data. As described above, a method in which the speaker directly receives audio data from the TV and reproduces same may be efficient compared to a method in which service data is relayed through a wireless access point.

In addition, in FIG. 7, a connection between the exchange device 710 and the first TV 720 and the second TV 750 may indicate a direct connection between devices in a distributed manner without a wireless access point and a central manager. That is, a connection between the exchange device 710 and the first TV 720 and the second TV 750 may be a wireless communication connection based on Wi-Fi aware. In wireless communication based on Wi-Fi aware, nodes configuring a network may each search for another adjacent node and establish a connection with the found node so as to perform one-to-one communication.

Each of the first TV 720, the second TV 750, and the exchange device 710 may include a communication module for supporting wireless communication based on Wi-Fi aware, and a one-to-one connection is established between the electronic devices for supporting wireless communication based on Wi-Fi aware so as to enable service data to be transmitted or received. Specifically, the first TV 720 and the second TV 650 may directly receive service data for streaming from the exchange device 710, and may reproduce the received service data. For example, the first TV 720 may receive service data for streaming from the exchange device 710 and reproduce the received service data. Simultaneously, the second TV 750 may receive service data for streaming from the exchange device 710 and reproduce the received service data.

For an operation based on the network structure of FIG. 7, the first TV 720 may perform communication based on Wi-Fi aware with the exchange device 710, and the first TV 720 may operate as a group owner in communication based on Wi-Fi direct with the first speaker 730 and the second speaker 740. That is, the first TV 720 may include both a first communication module for supporting a group owner in wireless communication based on Wi-Fi direct and a second communication module for supporting wireless communication based on Wi-Fi aware.

The first TV 720 may include a first chipset 7202 and a second chipset 7204. The first chipset 7202 may include the first communication module for supporting a group owner in wireless communication based on Wi-Fi direct. The second chipset 7204 may include the second communication module for supporting wireless communication based on Wi-Fi aware and a third communication module for supporting a group client in wireless communication based on Wi-Fi direct. The first chipset 7202 and the second chipset 7204 may indicate chipsets that are physically distinguished. A chipset may be referred to by similar terms such as a processor, a system on chip (SoC), a microcontroller (MCU), an application-specific integrated circuit (ASIC), and an integrated circuit (IC).

The first TV 720 may transmit service data for audio to the first speaker 730 and the second speaker 740 while reproducing service data for streaming received from the exchange device 710, and the first speaker 730 and the second speaker 740 reproduce the service data received from the first TV 720. From a perspective of a user, a streaming service and an audio service may be satisfied simultaneously.

In various embodiments, electronic devices such as a TV and a speaker may include a STA module for supporting a network connection through a wireless access point together with a Wi-Fi direct support module or a Wi-Fi aware support module.

In various embodiments, a type of a service provided to a user is not limited to an audio solution or streaming, and an electronic device according to embodiments of the disclosure may provide various services simultaneously, based on a communication module enabling communication based on Wi-Fi.

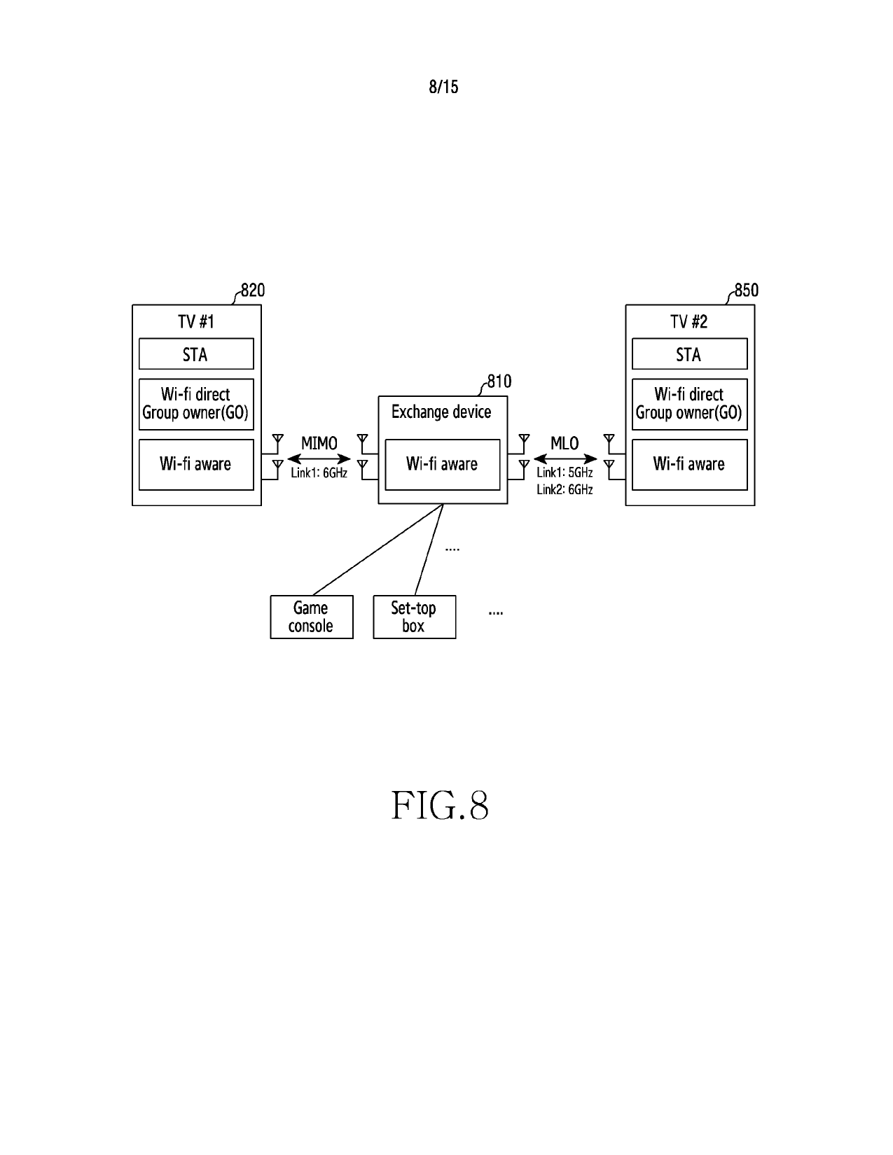

FIG. 8 illustrates an example of a communication mode based on Wi-Fi in a wireless LAN system according to an embodiment of the disclosure.

Referring to FIG. 8, an exchange device 810 may perform wireless communication based on Wi-Fi with a first TV 820 and a second TV 850. At this time, a device-to-device communication mode may include multiple input multiple output (MIMO) and multiple link operation (MLO). For example, the exchange device 810 may communicate with the first TV 820, based on MIMO and may communicate with the second TV 850, based on MLO.

In wireless communication technology, MIMO may indicate a communication scheme using one link based on multiple transmission antennas and multiple reception antennas. That is, MIMO may indicate a communication scheme using one link or a frequency band based on multiple transmission–reception antenna pairs. MLO may indicate a scheme in which different frequency bands are allocated to one or more links, respectively, and data is communicated. In an example, MLO may indicate a scheme in which, when one link is configured for each antenna pair, different frequency bands are allocated to multiple links corresponding to multiple antenna pairs, respectively and data is communicated. MLO may indicate a scheme in which one or more wireless frequency bands (e.g., 2.4 GHz, 5 GHz, or 6 GHz) respectively corresponding to one or more links are utilized simultaneously.

In FIG. 8, the exchange device 810 may perform communication based on MIMO with the first TV 820. That is, the exchange device 810 may transmit or receive data with the first TV 820 by using one link using a 6 GHz frequency band, based on multiple transmission–reception antenna pairs. In addition, the exchange device 810 may perform communication based on MLO with the second TV 850. The exchange device 810 may transmit or receive data with the second TV 850 by using multiple links using 5 GHz and 6 GHz frequency bands, respectively. That is, an electronic device according to embodiments of the disclosure may transmit or receive data with another electronic device, based on a MIMO mode or an MLO mode.

In various embodiments, communication modes such as MIMO and MLO may be referred to as a first communication mode and a second communication mode. In addition, a communication mode according to embodiments of the disclosure is not limited to MIMO and MLO and may include various communication modes according to various configurations.

In various embodiments, communication based on MLO may indicate a scheme in which a dual band or a tri band is allocated to each transmission–reception antenna pair and data is transmitted or received. In relation to a scheme of allocating two types of bands simultaneously, terms such as Real-time Dual-Band (RSDB), Dual-Band Simultaneous (DBS), or Dual-Band Dual Concurrency (DBDC) may be referred to as. In addition, in relation to a scheme of allocating three types of bands, terms such as Real-time Tri-Band (RSTB), Tri-Band Simultaneous (TBS), or Tri-Band Tri Concurrency (TBTC) may be referred to as. A technical idea described in embodiments of the disclosure is not limited and interpreted by particular terms.

An electronic device according to embodiments of the disclosure may select a communication mode for transmitting and receiving data. For example, the electronic device may measure throughput and latency according to a communication mode based on quality of a wireless link, traffic, or quality-of-service (QoS) information, and may select the communication mode according to a result of the measurement.

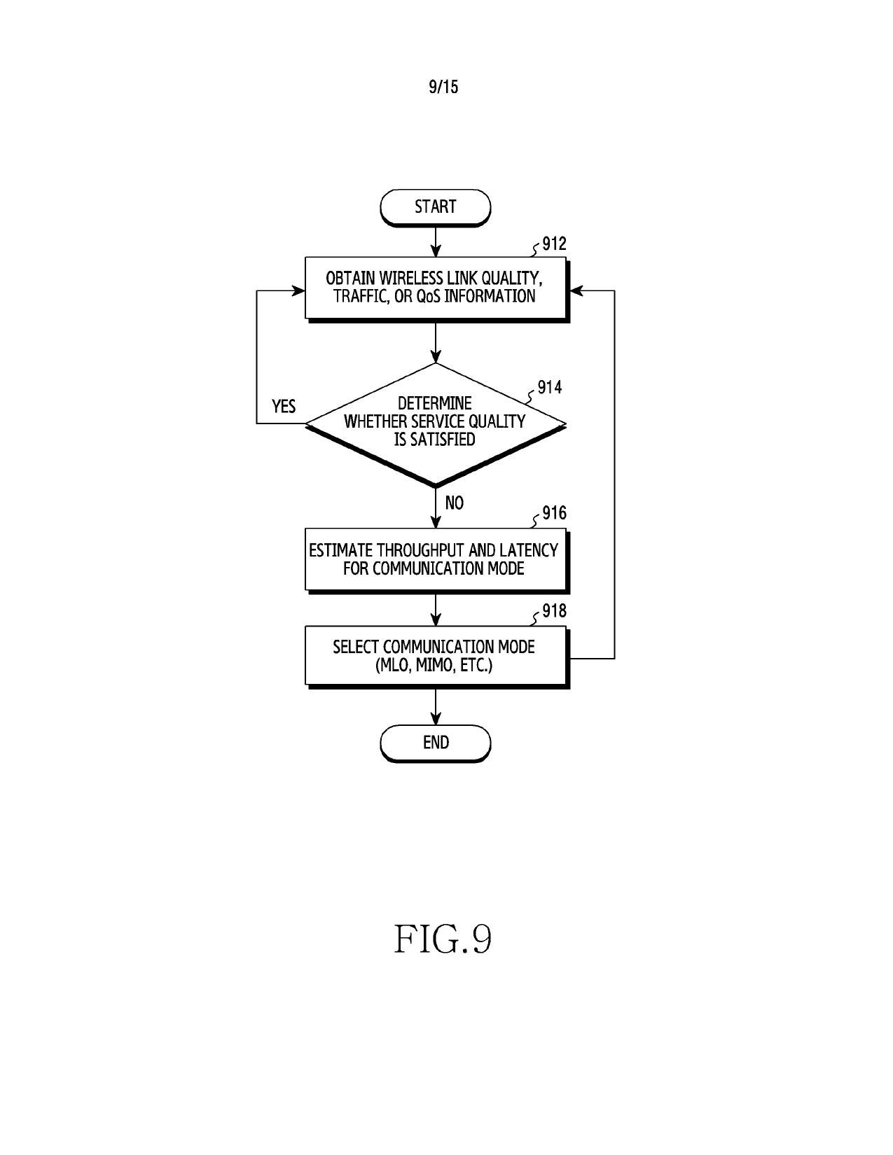

FIG. 9 illustrates a process in which an electronic device selects or changes a communication mode according to an embodiment of the disclosure.

An electronic device that performs operations described with reference to FIG. 9 may correspond to the first device 100 or the second device 200 in FIG. 1. In addition, the electronic device that performs the operations described with reference to FIG. 9 may correspond to the TV, the speaker, or the exchange device of FIG. 3 to FIG. 8, and also correspond to a user equipment.

Referring to FIG. 9, a method performed by the electronic device according to embodiments of the disclosure may include operation 912 of acquiring a wireless link quality, traffic information, or QoS information, operation 914 of determining whether a quality of a service is satisfied, based on the acquired information, operation 916 of estimating information on a data throughput and a latency for a communication mode, and/or operation 918 of selecting the communication mode, based on the estimated information.

In operation 912, the electronic device may obtain a wireless link quality, traffic information, or QoS information. For example, the electronic device may acquire at least one of pieces of information on reference signal received power (RSRP), received signal strength indicator (RSSI), signal-to-interference-plus-noise ratio (SINR), signal-to-noise ratio (SNR), bit error rate (BER), block error rate (BLER), delay time (latency), jitter, or packet loss rate. In addition, the electronic device may acquire at least one of pieces of information on data throughput indicating an amount of data transmitted per unit time, traffic load indicating an amount of used resources, a usage rate of network bandwidth, or peak traffic indicating a maximum traffic level during a particular time. An operation of acquiring the above information may include a method in which the electronic device measures and acquires the information by itself, or a method in which the electronic device transmits a signal for measuring a quality of a link and receives a measurement value reported from a reception-side device.

Operation 914 indicates an operation in which the electronic device determines whether a quality of a service is satisfied, based on the information acquired in operation 912. When the electronic device determines that the service quality is satisfied, the electronic device may perform operation 912 again. When the electronic device determines that the service quality is not satisfied, the electronic device may perform operation 916. The electronic device may determine whether the service quality is satisfied by comparing the acquired information with a particular threshold value.

Operation 916 indicates an operation in which the electronic device estimates a data throughput and a latency for a communication mode. Specifically, the electronic device may estimate a transmission speed and a latency of a communication mode (a MIMO mode or an MLO mode), based on the information acquired in operation 912. In this case, a method of estimating the transmission speed and the latency may be a method using a known algorithm. A communication mode according to embodiments of the disclosure is not limited to the MIMO mode or the MLO mode and may include various modes depending on a configuration.

Operation 918 indicates an operation in which the electronic device selects a communication mode, based on a result estimated in operation 916. For example, the electronic device may select one communication mode among MIMO or MLO by comparing a data throughput (transmission speed) and/or a latency estimated for the MIMO mode with a data throughput (transmission speed) and/or a latency estimated for the MLO mode. After selecting the communication mode, the electronic device may perform operation 912 again.

In various embodiments, communication based on MLO may indicate a scheme in which a dual band or a tri band is allocated to each transmission–reception antenna pair and data is transmitted or received. In relation to a scheme of allocating two types of bands simultaneously, terms such as Real-time Dual-Band (RSDB), Dual-Band Simultaneous (DBS), or Dual-Band Dual Concurrency (DBDC) may be referred to as. In addition, in relation to a scheme of allocating three types of bands, terms such as Real-time Tri-Band (RSTB), Tri-Band Simultaneous (TBS), or Tri-Band Tri Concurrency (TBTC) may be referred to as. A technical idea described in embodiments of the disclosure is not limited and interpreted by particular terms.

In various embodiments, one of the operations described in FIG. 9 may be omitted, and an order of the operations may be changed. In addition, in relation to the operations described with reference to FIG. 9, multiple operations may be combined and expressed as a single operation, or a single operation may be divided into subdivided operations. The method performed by the electronic device according to embodiments of the disclosure may include an embodiment in which the operations described with reference to FIG. 9 are modified.

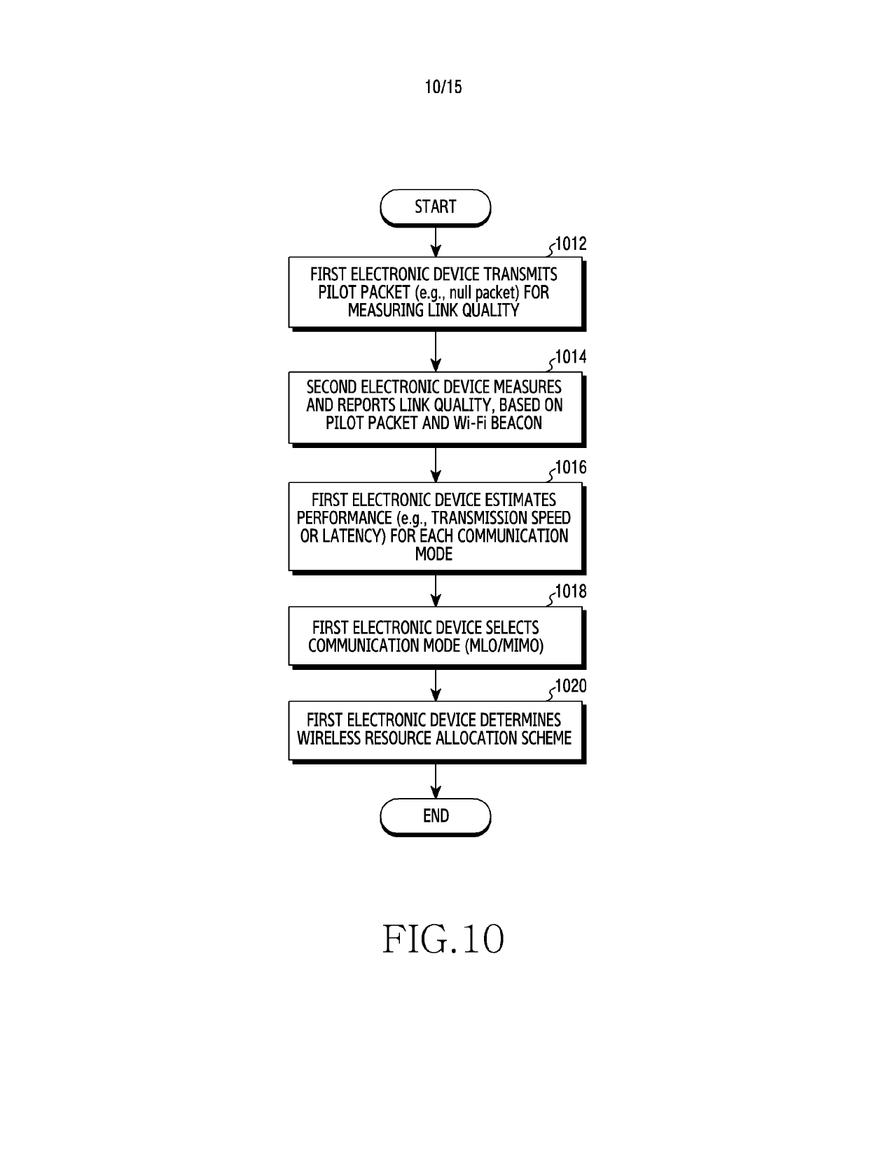

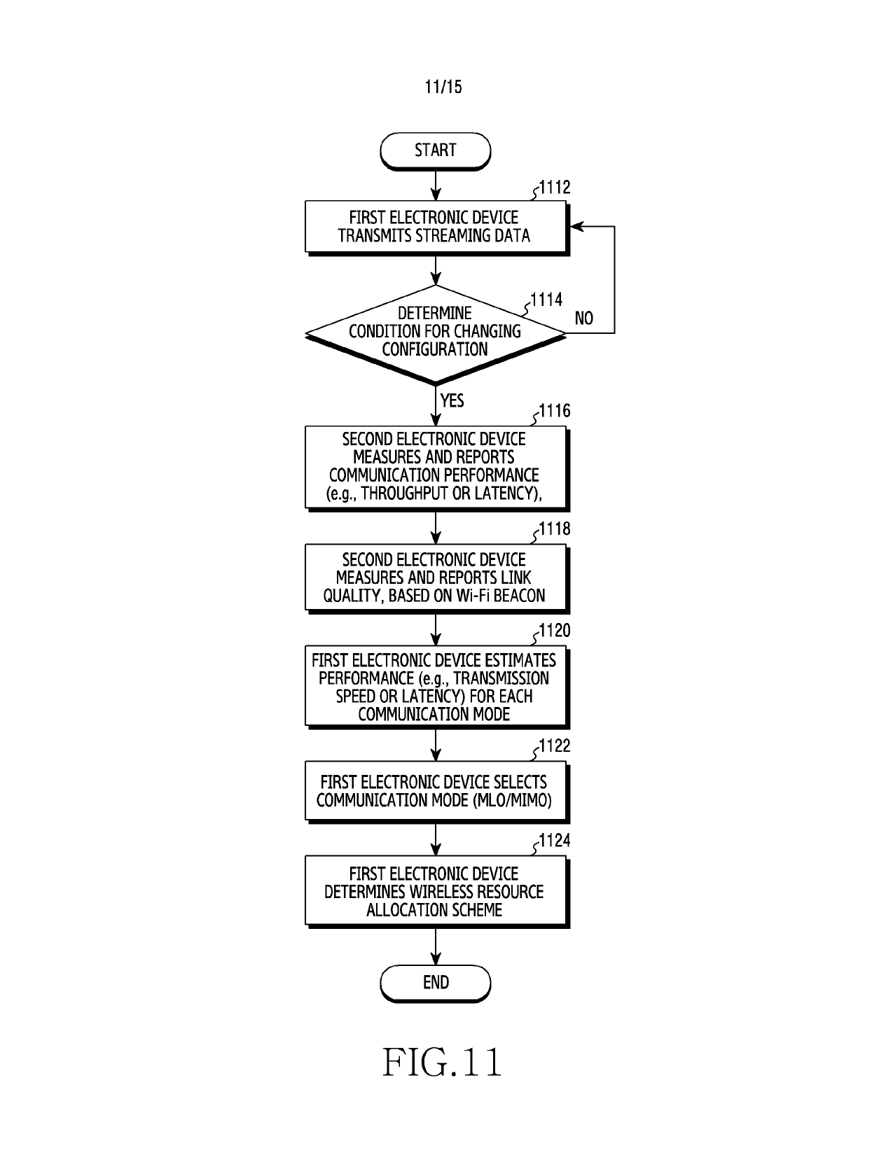

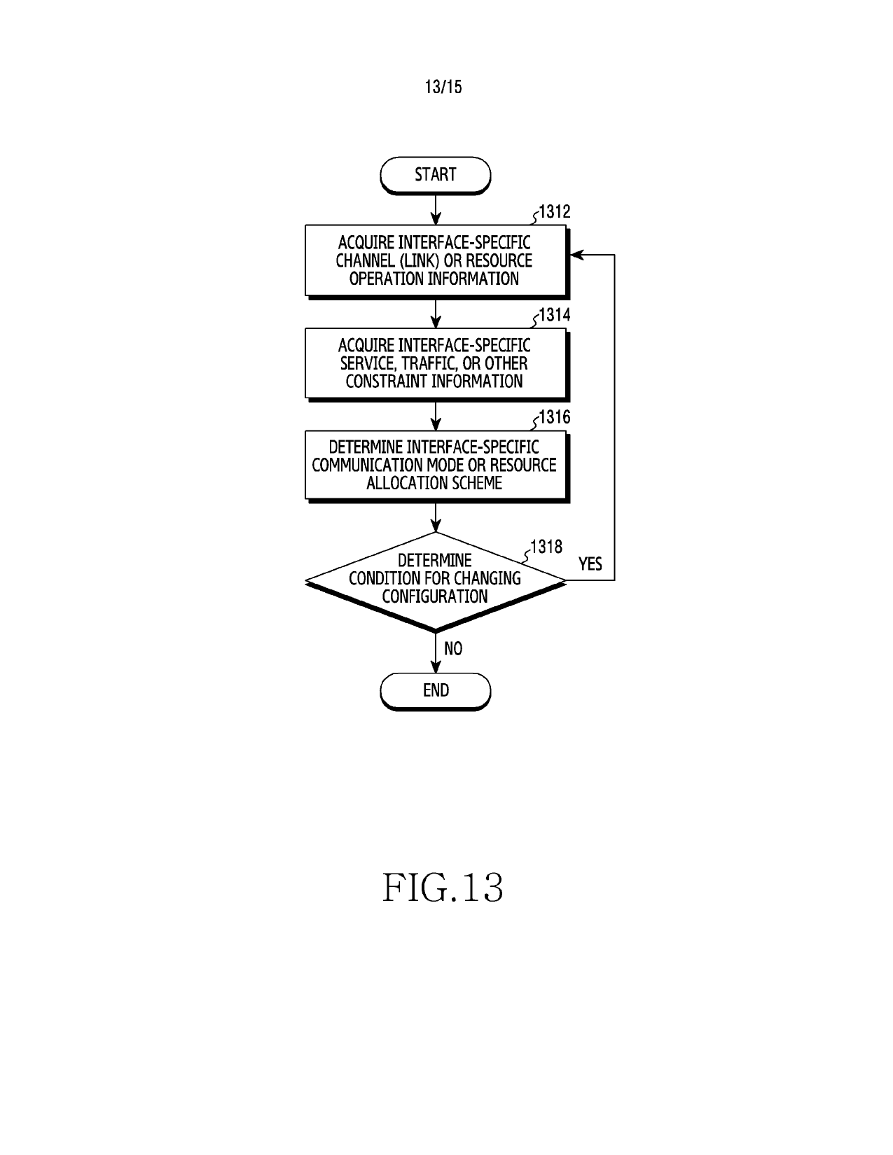

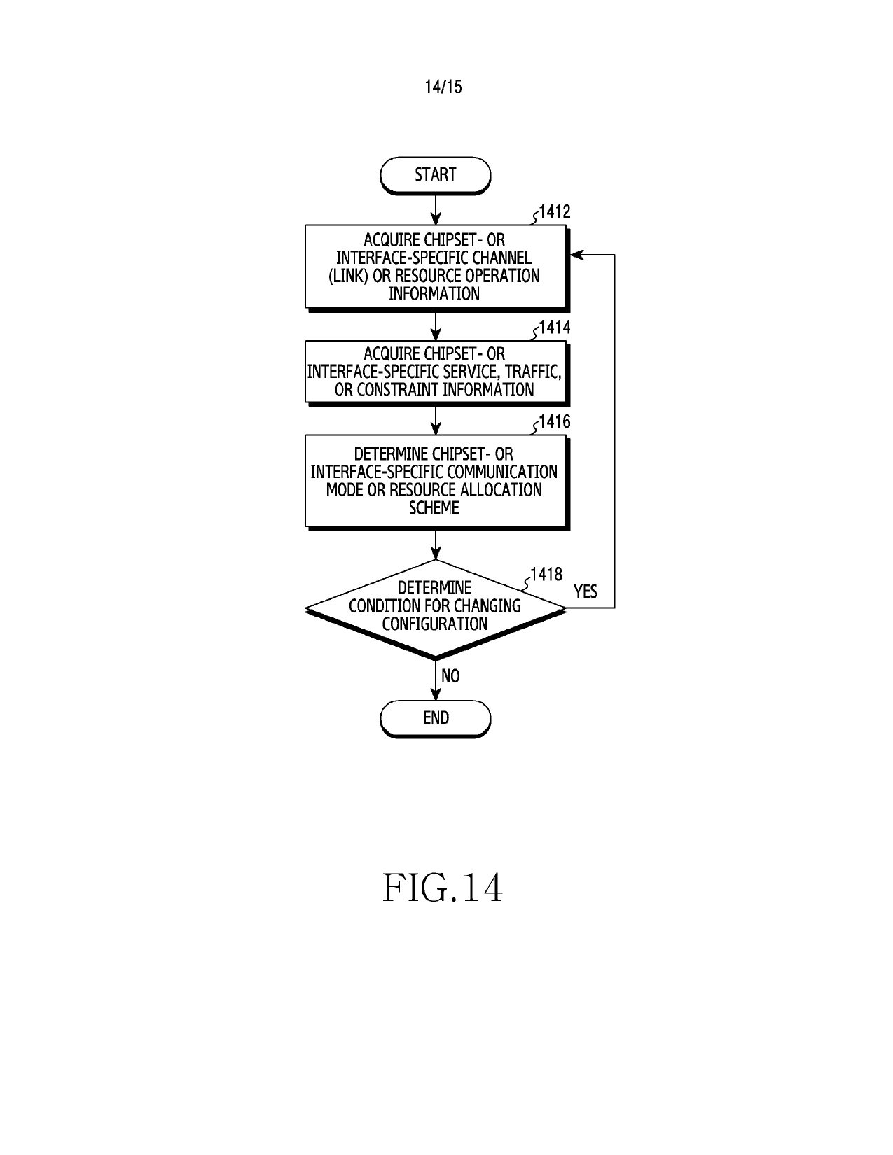

The operations of FIG. 9 may configure a new embodiment in combination with the operations of FIG. 10, FIG. 11, FIG. 13, or FIG. 14.

FIG. 10 illustrates a process in which an electronic device selects a communication mode and determines a wireless resource allocation scheme according to an embodiment of the disclosure.

An electronic device that performs operations described with reference to FIG. 10 may correspond to the first device 100 or the second device 200 in FIG. 1. In addition, the electronic device that performs the operations described with reference to FIG. 10 may correspond to the TV, the speaker, or the exchange device of FIG. 3 to FIG. 8, and also correspond to a user equipment.

Referring to FIG. 10, a method performed by the electronic device according to embodiments of the disclosure may include operation 1012 of transmitting a packet for measuring a quality of a link, operation 1014 of measuring and reporting a quality of a link, operation 1016 of estimating performance for each communication mode, operation 1018 of selecting a communication mode, based on the estimated performance, and/or operation 1020 of determining a scheme of allocating a wireless resource.

Operation 1012 indicates an operation in which a first electronic device (or a transmission-side electronic device) transmits a pilot packet or a null packet to measure a quality of a link. The pilot packet or the null packet may indicate a packet that does not include service data for a purpose of measuring a quality of a link. Operation 1012 may indicate an operation in which the electronic device transmits a signal for measuring a quality of a link. In an embodiment, the signal for measuring a quality of a link may include a Wi-Fi beacon frame.

Operation 1014 indicates an operation of measuring and reporting a quality of a link, based on the pilot packet or null packet or the Wi-Fi beacon frame transmitted in operation 1012. That is, operation 1014 may be performed in a second electronic device (or a reception-side electronic device) that receives the signal transmitted in operation 1012.

The Wi-Fi beacon frame may be a signal transmitted by an access point (AP) in a Wi-Fi-based network structure. In addition, the Wi-Fi beacon frame may be transmitted by a group owner functioning as a central manager in a Wi-Fi direct-based network. In addition, the Wi-Fi beacon frame may be transmitted by one of nodes participating in a network in Wi-Fi aware-based communication.

The second electronic device (or the reception-side electronic device) may measure a quality of a link by receiving the Wi-Fi beacon frame or by receiving the pilot packet or the null packet. Information indicating a quality of a link that is measurable in the second electronic device may include at least one of pieces of information on reference signal received power (RSRP), received signal strength indicator (RSSI), signal-to-interference-plus-noise ratio (SINR), signal-to-noise ratio (SNR), bit error rate (BER), block error rate (BLER), latency, jitter, or packet loss rate. In addition, the information indicating a quality of a link may include at least one of pieces of information on data throughput indicating an amount of data transmitted per unit time, traffic load indicating an amount of used resources, a usage rate of network bandwidth, or peak traffic indicating a maximum traffic level during a particular time. The second electronic device may report the acquired information to the first electronic device. Therefore, the first electronic device may receive, from the second electronic device, a report on a measurement value or a quality of a link for the signal transmitted in operation 1012.

Operation 1016 may indicate an operation in which the first electronic device estimates performance for each communication mode, based on information on the quality of the link or the measurement value included in the report received in operation 1014. For example, the first electronic device may estimate a data transmission speed and a latency when a communication mode is MIMO or MLO. In this case, a method of estimating the data transmission speed and the latency may be performed based on a known algorithm.

Operation 1018 indicates an operation in which the first electronic device selects a communication mode, based on performance of the communication mode estimated in operation 1016. For example, the electronic device may select one communication mode among a MIMO mode or a MLO mode by comparing a data throughput and/or a latency estimated for the MIMO mode with a data throughput and/or a latency estimated for the MLO mode. The communication mode is not limited to the MIMO mode or the MLO mode and may include various modes depending on a configuration.

In various embodiments, the first electronic device may select a communication mode for each chipset. For example, when the first electronic device includes multiple chipsets including communication modules, the first electronic device may select a communication mode for each chipset. In addition, the first electronic device may select a communication mode for each communication module. For example, when the first electronic device includes a communication module supporting Wi-Fi direct and a communication module supporting Wi-Fi aware, the first electronic device may select a communication mode to be applied to each communication module. Alternatively, the first electronic device may select a communication mode for each interface (Wi-Fi direct-based or Wi-Fi aware-based).

In various embodiments, communication based on MLO may indicate a scheme in which a dual band or a tri band is allocated to each transmission–reception antenna pair and data is transmitted or received. In relation to a scheme of allocating two types of bands simultaneously, terms such as Real-time Dual-Band (RSDB), Dual-Band Simultaneous (DBS), or Dual-Band Dual Concurrency (DBDC) may be referred to as. In addition, in relation to a scheme of allocating three types of bands, terms such as Real-time Tri-Band (RSTB), Tri-Band Simultaneous (TBS), or Tri-Band Tri Concurrency (TBTC) may be referred to as. A technical idea described in embodiments of the disclosure is not limited and interpreted by particular terms.

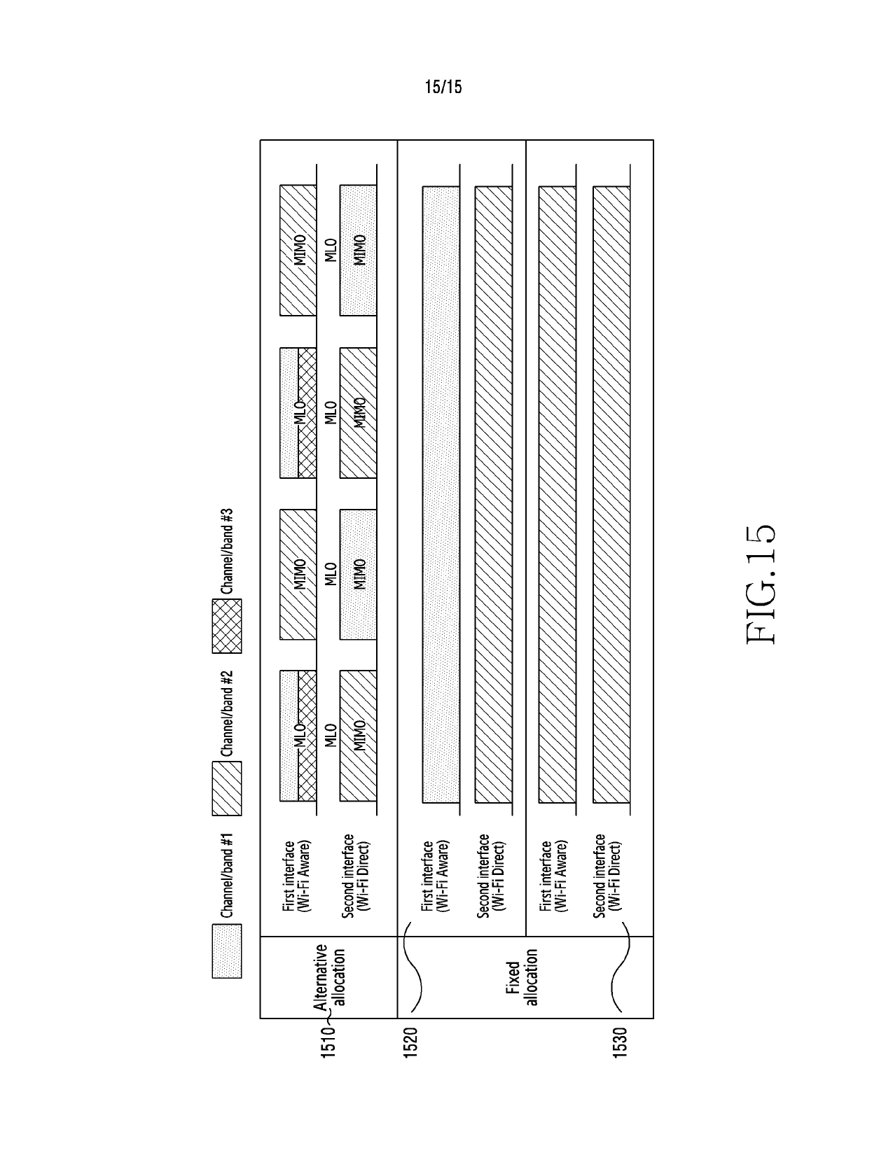

Operation 1020 indicates an operation in which the first electronic device determines a scheme of allocating a wireless resource associated with transmission or reception of data. For example, the electronic device may determine a scheme of allocating a time resource and a frequency resource for each interface for wireless communication. That is, the electronic device may allocate a wireless resource to a communication module supporting Wi-Fi direct and to a communication module supporting Wi-Fi aware. Alternatively, the electronic device may allocate a corresponding wireless resource to each link for a communication mode (e.g., an MLO mode) in which multiple links are simultaneously used to transmit data. FIG. 15 may be referenced in relation to a scheme of allocating a wireless resource.

In various embodiments, the first electronic device may allocate a wireless resource for each chipset, for each communication module (or interface), or for each link.

In relation to operation 1018 and operation 1020, depending on the selected communication mode, different frequency bands may be allocated to multiple links for each interface, respectively, or one frequency band may be allocated to one link for each interface. That is, the operation of selecting a communication mode is directly related to allocating a wireless resource. Therefore, although operation 1018 and operation 1020 are expressed as two separate operations, the operations may be performed simultaneously.

In the embodiment of FIG. 10, the second electronic device (the reception-side electronic device) may measure a signal received from the first electronic device (the transmission-side electronic device) and may acquire information on a quality of a link. The second electronic device may also estimate performance for each communication mode, select a communication mode, and determine a wireless resource allocation scheme, similarly to the first electronic device. As described above, when the first electronic device and the second electronic device select respective communication modes and determine respective wireless resource allocation schemes, an operation of negotiating the selected communication modes and the determined wireless resource allocation schemes between the first electronic device and the second electronic device may be additionally required.

In the embodiment of FIG. 10, the first electronic device may be a TV, and the second electronic device may be a speaker. In addition, the first electronic device may be an exchange device, and the second electronic device may be a TV. In addition, the first electronic device may be a user equipment, and the second electronic device may be a TV. That is, the first electronic device and the second electronic device may each be various electronic devices.

According to the method performed by the electronic device according to embodiments of the disclosure, the above-described operations may be periodically or aperiodically repeated to select a communication mode appropriate for a wireless link environment and to determine a wireless resource allocation scheme.

In various embodiments, one of the operations described in FIG. 10 may be omitted, and an order of the operations may be changed. In addition, in relation to the operations described with reference to FIG. 10, multiple operations may be combined and expressed as a single operation, or a single operation may be divided into subdivided operations. The method performed by the electronic device according to embodiments of the disclosure may include an embodiment in which the operations described with reference to FIG. 10 are modified.

FIG. 11 illustrates a process in which an electronic device selects a communication mode and determines a wireless resource allocation scheme during a streaming service according to an embodiment of the disclosure.

An electronic device that performs operations described with reference to FIG. 11 may correspond to the first device 100 or the second device 200 in FIG. 1. In addition, the electronic device that performs the operations described with reference to FIG. 11 may correspond to the TV, the speaker, or the exchange device of FIG. 3 to FIG. 8, and also correspond to a user equipment.

An embodiment of FIG. 11 indicates operations for measuring a quality of a wireless link and selecting a communication mode or determining a wireless resource allocation scheme in a process in which the electronic device provides a streaming service or another service.

Referring to FIG. 11, a method performed by the electronic device may include operation 1112 of transmitting streaming data, operation 1114 of determining a condition for changing a configuration, operation 1116 of measuring communication performance, operation 1118 of measuring a link quality, operation 1120 of estimating performance for each communication mode, operation 1122 of selecting a communication mode, and/or operation 1124 of determining a wireless resource allocation scheme.

In operation 1112, a first electronic device (or a transmission-side electronic device) may transmit streaming data. For example, the operation may indicate an operation in which an exchange device transmits streaming data to a TV. In an embodiment, operation 1112 may indicate an operation in which the first electronic device transmits data for another service in addition to streaming data. That is, a type of transmitted data is not limited to data for a streaming service.

In operation 1116, the first electronic device may determine whether a condition for changing a configuration is satisfied. The configuration may indicate a configuration related to a communication mode of the electronic device or a configuration related to a wireless resource allocation scheme. The condition for changing the configuration may include at least one of the following conditions.

Condition 1) A new service is initiated. For example, Condition 1 may indicate a case in which an audio service is newly initiated in the electronic device.

Condition2) An existing service is terminated. For example, Condition 2 may indicate a case in which an existing service being performed in the electronic device is terminated.

Condition 3) A change in QoS or in an amount of traffic. For example, Condition 3 may indicate a case in which a QoS or an amount of traffic is changed by a particular threshold value or more.

Condition 4) A pre-configured period starts. For example, the electronic device may perform measurement of communication performance or measurement of a link quality to change the configuration whenever the pre-configured period starts.

In operation 1116, when it is determined that one of the above conditions is satisfied, a second electronic device (or a reception-side electronic device) may measure and report communication performance. Operation 1116 may correspond to operation 1014 of FIG. 10.

The measurement of the communication performance may be performed based on the streaming data received by the second electronic device in operation 1112. The second electronic device may measure information on a link quality, such as data throughput and latency, through reception of the streaming data.

In addition, in operation 1118, the second electronic device may measure and report a link quality based on a Wi-Fi beacon. For example, the second electronic device may receive a Wi-Fi beacon frame (or a signal) from the first electronic device, and may measure and report a quality of a wireless link through measurement of the received signal. In an embodiment, the second electronic device may receive a reference signal for measuring a quality of a wireless link from the first electronic device. That is, a signal for measuring a quality of a wireless link is not limited to a Wi-Fi beacon.

The Wi-Fi beacon frame may be a signal transmitted by an access point (AP) in a Wi-Fi-based network structure. In addition, the Wi-Fi beacon frame may be transmitted by a group owner functioning as a central manager in a Wi-Fi direct-based network. In addition, the Wi-Fi beacon frame may be transmitted by one of nodes participating in a network in Wi-Fi aware-based communication.

Information indicating a quality of a link that is measurable in the second electronic device may include at least one of pieces of information on reference signal received power (RSRP), received signal strength indicator (RSSI), signal-to-interference-plus-noise ratio (SINR), signal-to-noise ratio (SNR), bit error rate (BER), block error rate (BLER), latency, jitter, or packet loss rate. In addition, the information indicating a quality of a link may include at least one of pieces of information on data throughput indicating an amount of data transmitted per unit time, traffic load indicating an amount of used resources, a usage rate of network bandwidth, or peak traffic indicating a maximum traffic level during a particular time.

The second electronic device may report the information measured in operation 1116 or operation 1118 to the first electronic device. Therefore, the first electronic device may receive, from the second electronic device, a report on a measurement value or a quality of a link for the Wi-Fi beacon frame or the data transmitted in operation 1112.

In operation 1120, the first electronic device may estimate performance for each communication mode. The communication mode may include a MIMO mode or an MLO mode. In an embodiment, the communication mode may include more various communication modes depending on configurations that are changed in detail. The first electronic device may estimate a communication speed and a latency for each communication mode, based on information included in the report received from the second electronic device. The communication speed and the latency may be estimated based on a known algorithm. Operation 1120 may correspond to operation 1016 of FIG. 10.

In operation 1122, the first electronic device may select a communication mode, based on a result estimated in operation 1120. For example, the electronic device may select one communication mode among the MIMO mode or the MLO mode by comparing a data throughput and/or a latency estimated for the MIMO mode with a data throughput and/or a latency estimated for the MLO mode. Operation 1122 may correspond to operation 1018 of FIG. 10.

In various embodiments, the first electronic device may select a communication mode for each chipset. For example, when the first electronic device includes multiple chipsets including communication modules, the first electronic device may select a communication mode for each chipset. In addition, the first electronic device may select a communication mode for each communication module. For example, when the first electronic device includes a communication module supporting Wi-Fi direct and a communication module supporting Wi-Fi aware, the first electronic device may select a communication mode to be applied to each communication module. Alternatively, the first electronic device may select a communication mode for each interface (Wi-Fi direct-based or Wi-Fi aware-based).

In operation 1124, the electronic device may determine a scheme of allocating a wireless resource. For example, the electronic device may determine a scheme of allocating a time resource and a frequency resource for each interface for wireless communication. That is, the electronic device may allocate a wireless resource to a communication module supporting Wi-Fi direct and to a communication module supporting Wi-Fi aware. Alternatively, the electronic device may allocate a corresponding wireless resource to each link for a communication mode in which multiple links are simultaneously used to transmit data. FIG. 15 may be referenced in relation to a scheme of allocating a wireless resource.

In various embodiments, the first electronic device may allocate a wireless resource for each chipset, for each communication module (or interface), or for each link.

In relation to operation 1122 and operation 1124, depending on the selected communication mode, different frequency bands may be allocated to multiple links for each interface, respectively, or one frequency band may be allocated to one link for each interface. That is, the operation of selecting a communication mode is directly related to allocating a wireless resource. Therefore, although operation 1122 and operation 1124 are expressed as two separate operations, the operations may be performed simultaneously.

In the embodiment of FIG. 11, the second electronic device (the reception-side electronic device) may measure a signal received from the first electronic device (the transmission-side electronic device) and may acquire information on a quality of a link. The second electronic device may also estimate performance for each communication mode, select a communication mode, and determine a wireless resource allocation scheme, similarly to the first electronic device. As described above, when the first electronic device and the second electronic device select respective communication modes and determine respective wireless resource allocation schemes, an operation of negotiating the selected communication modes and the determined wireless resource allocation schemes between the first electronic device and the second electronic device may be additionally required.

In the embodiment of FIG. 11, the first electronic device may be a TV, and the second electronic device may be a speaker. In addition, the first electronic device may be an exchange device, and the second electronic device may be a TV. In addition, the first electronic device may be a user equipment, and the second electronic device may be a TV. That is, the first electronic device and the second electronic device may each be various electronic devices.

In various embodiments, one of the operations described in FIG. 11 may be omitted, and an order of the operations may be changed. In addition, in relation to the operations described with reference to FIG. 11, multiple operations may be combined and expressed as a single operation, or a single operation may be divided into subdivided operations. The method performed by the electronic device according to embodiments of the disclosure may include an embodiment in which the operations described with reference to FIG. 11 are modified.

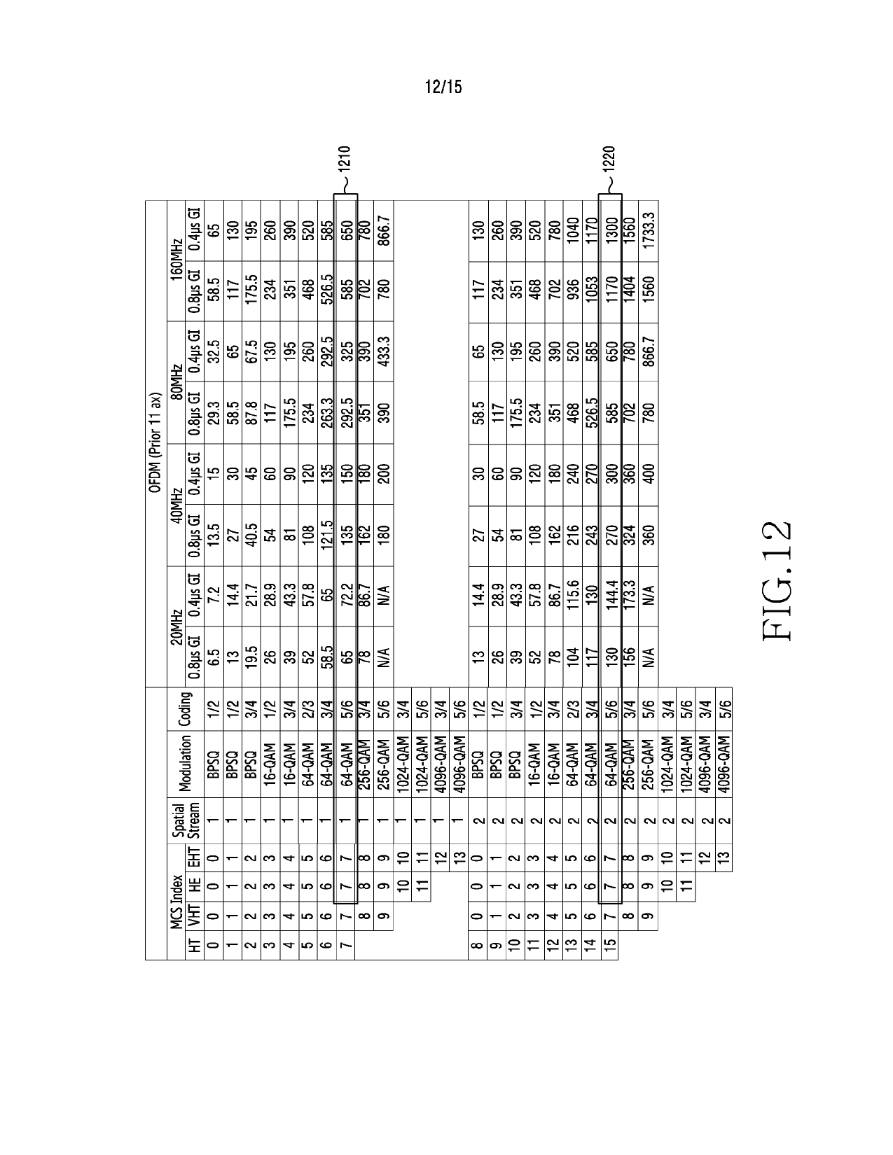

FIG. 12 illustrates a comparison between data transmission speeds of communication modes according to an embodiment of the disclosure.

Referring to FIG. 12, maximum data transmission speeds according to a modulation coding scheme (MCS) index and the number of spatial streams are presented. Based on contents of the table shown in FIG. 12, a transmission speed according to a communication mode may be estimated. For example, data transmission speeds indicated by reference numerals 1210 and 1220 may be compared with each other.

In the case of reference numeral 1210, an MCS index is 7, and a spatial stream is 1. The spatial stream may be understood as indicating the number of independent messages transmitted through a link. The spatial stream may be associated with the number of transmission or reception antennas. For example, the spatial stream may correspond to a maximum value of a rank, and the maximum value of the rank calculated based on a channel matrix may correspond to a smaller number among the number of transmission antennas and the number of reception antennas. When a communication mode of an electronic device is MLO, one link may be configured for each transmission-reception antenna pair, and a different frequency bandwidth may be allocated to each link. For example, when two transmission-reception antenna pairs exist, an 80 MHz bandwidth in a channel having a center frequency of 5 GHz may be allocated to a first link based on a first transmission-reception antenna pair, and a 160 MHz bandwidth in a channel having a center frequency of 6 GHz may be allocated to a second link based on a second transmission-reception antenna pair. Referring to FIG. 12, in a case where the electronic device transmits data by using such a configuration, when the data is transmitted using an MCS index of 7 in the first link using the 80 MHz bandwidth, a maximum transmission speed is 325 Mbps, and when the data is transmitted using an MCS index of 7 in the second link using the 160 MHz bandwidth, a maximum transmission speed is 650 Mbps. Therefore, it is noted that a total data transmission speed using the two links is 975 Mbps.

On the contrary, in the case of reference numeral 1220, an MCS index is 7, and a spatial stream is 2. The spatial stream may be understood as indicating the number of independent messages transmitted through a link. When a communication mode of the electronic device is MIMO, one link may be configured for multiple transmission-reception antenna pairs. For example, when two transmission-reception antenna pairs exist, a 160 MHz bandwidth in a channel having a center frequency of 6 GHz may be allocated to one link based on a first transmission-reception antenna pair and a second transmission-reception antenna pair. Referring to FIG. 12, when the electronic device transmits data by using such a configuration, a maximum transmission speed of the link using the 160 MHz bandwidth is indicated as 1300 Mbps. That is, a speed of one link using the two transmission-reception antenna pairs is 1300 Mbps.

Therefore, in comparison of reference numerals 1210 and 1220, when other conditions such as an MCS index, a modulation scheme, and a coding rate are identical, a communication speed based on MIMO may be better than a communication speed based on MLO.

An electronic device according to embodiments of the disclosure may include multiple antennas, and may transmit data by selecting one of a mode (MIMO) in which communication is performed through one link based on multiple antenna pairs, and a mode (MLO) in which communication is performed through multiple links such as multiple antenna pairs. In an embodiment, the electronic device may estimate a transmission speed for each communication mode, based on the table shown in FIG. 12, and may select a communication mode, based on the estimated transmission speed.

FIG. 13 illustrates a process in which an electronic device selects a communication mode and determines a wireless resource allocation scheme according to an embodiment of the disclosure.

An electronic device that performs operations described with reference to FIG. 13 may correspond to the first device 100 or the second device 200 in FIG. 1. In addition, the electronic device that performs the operations described with reference to FIG. 13 may correspond to the TV, the speaker, or the exchange device of FIG. 3 to FIG. 8, and also correspond to a user equipment.

An embodiment of FIG. 13 indicates operations in which the electronic device determines a communication mode or a resource allocation scheme, based on interface-specific link or resource operation information or constraint information regarding a service or traffic, which are obtainable by the electronic device itself. The operations shown in the embodiment of FIG. 13 may be performed in combination with the operations of FIG. 9 and FIG. 10 to determine a communication mode or a wireless resource allocation scheme.

Referring to FIG. 13, a method performed by the electronic device may include operation 1312 of acquiring interface-specific link and wireless resource operation information, operation 1314 of acquiring interface-specific service, traffic, or constraint information, operation 1316 of determining an interface-specific communication mode or wireless resource allocation scheme, and/or operation 1318 of determining a condition for changing a configuration.

In operation 1312, the electronic device may acquire information on an interface-specific link and wireless resource operation. For example, the electronic device may acquire information on wireless resource operation and a link for Wi-Fi direct-based communication and/or information on wireless resource operation and a link for Wi-Fi aware-based communication. For example, the electronic device may acquire information on a frequency band and a bandwidth of an interface-specific link, and information on a frequency band and a bandwidth of each link according to a communication mode, and acquire information on a scheme of operating a wireless resource allocated to each link. In addition, the electronic device may acquire information on a frequency band and a bandwidth for each chipset. Various other information may also be considered, such as the number of links, a link formation scheme, and a scheme of operating a time resource. FIG. 15 may be referenced in relation to a scheme of operating a wireless resource. Such information may be pre-configured in the electronic device, or may be acquired by the electronic device by itself by another method.

In operation 1314, the electronic device may acquire interface-specific service, traffic, or constraint information. For example, the electronic device may acquire service, traffic, or other constraint information for Wi-Fi direct-based communication and/or service or traffic limitation, or other constraint information for Wi-Fi aware-based communication. Specifically, such information may include a requirement for a data transmission speed or latency for each service, or a maximum or minimum traffic limitation condition. Such information may be pre-configured in the electronic device, or may be acquired by the electronic device by itself by another method.

In various embodiments, operation 1312 and operation 1314 may be performed in a different order or may be performed simultaneously.

In operation 1316, the electronic device may determine an interface-specific communication mode or wireless resource allocation scheme. The electronic device may determine a communication mode or a wireless resource allocation scheme, based on the information acquired in operation 1312 and operation 1314. That is, a communication mode or a wireless resource allocation scheme may be determined based on interface-specific information on a wireless resource allocated to a link, a limitation condition for a service or traffic, or other constraint conditions.

In operation 1318, the electronic device may determine whether a condition for changing a configuration is satisfied. The configuration may indicate a configuration related to a communication mode of the electronic device or a configuration related to a wireless resource allocation scheme. The condition for changing the configuration may include at least one of the following conditions.

Condition 1) A connection of an existing interface is terminated. For example, Condition 1 may indicate a case in which Wi-Fi direct-based communication or Wi-Fi aware-based communication currently being performed in the electronic device is terminated.

Condition 2) A connection of a new interface is initiated. For example, Condition 2 may indicate a case in which the electronic device newly initiates Wi-Fi direct-based communication or Wi-Fi aware-based communication. In the case of a TV, Condition 2 may indicate a case in which the TV initiates Wi-Fi direct-based communication with a speaker for an audio service while the TV is receiving service data for streaming through Wi-Fi aware-based communication from an exchange device.

Condition 3) A change in QoS or in an amount of traffic. For example, Condition 3 may indicate a case in which a QoS or an amount of traffic is changed by a particular threshold value or more.

In operation 1318, when the electronic device determines that the condition for changing the configuration is satisfied, the electronic device may perform operation 1312 again. That is, whenever the condition for changing the configuration is satisfied, the electronic device may repeatedly perform an operation of acquiring information for determining a communication mode or a wireless resource allocation scheme, and determining the communication mode or the wireless resource allocation scheme, based on the acquired information. In an embodiment, the conditions for changing the configuration described in FIG. 13 may be combined with the conditions for changing the configuration described in FIG. 11.

In various embodiments, one of the operations described in FIG. 13 may be omitted, and an order of the operations may be changed. In addition, in relation to the operations described with reference to FIG. 13, multiple operations may be combined and expressed as a single operation, or a single operation may be divided into subdivided operations. The method performed by the electronic device according to embodiments of the disclosure may include an embodiment in which the operations described with reference to FIG. 13 are modified.

The operations described in the embodiment of FIG. 13 may be combined with the operations described in the embodiment of FIG. 9, FIG. 10, or FIG. 11 to configure a new embodiment.

FIG. 14 illustrates a process in which an electronic device selects a communication mode and determines a wireless resource allocation scheme according to an embodiment of the disclosure.

An electronic device that performs operations described with reference to FIG. 14 may correspond to the first device 100 or the second device 200 in FIG. 1. In addition, the electronic device that performs the operations described with reference to FIG. 14 may correspond to the TV, the speaker, or the exchange device of FIG. 3 to FIG. 8, and also correspond to a user equipment.

An embodiment of FIG. 14 indicates operations in which the electronic device determines a communication mode or a resource allocation scheme, based on chipset- or interface-specific link or resource operation information or constraint information regarding a service or traffic, which are obtainable by the electronic device itself. The operations shown in the embodiment of FIG. 14 may be performed in combination with the operations of FIG. 9, FIG. 10, and FIG. 13 to determine a communication mode or a wireless resource allocation scheme.

Referring to FIG. 14, a method performed by the electronic device may include operation 1412 of acquiring chipset- or interface-specific link and wireless resource operation information, operation 1414 of acquiring chipset- or interface-specific service, traffic, or constraint information, operation 1416 of determining a chipset- or interface-specific communication mode or wireless resource allocation scheme, and/or operation 1418 of determining a condition for changing a configuration.

In the embodiment of FIG. 14, chipset-specific information may be considered, and a chipset-specific communication mode or wireless resource allocation scheme may be determined. In the embodiment of FIG. 14, an electronic device may include multiple chipsets related to communication based on Wi-Fi, and each chipset may include a communication module for supporting communication based on Wi-Fi direct and/or a communication module for supporting communication based on Wi-Fi aware. In this case, the electronic device may acquire chipset-specific information and, based on the acquired information, determine a communication mode or a wireless resource allocation scheme.

In operation 1412, the electronic device may acquire c information on a chipset- or interface-specific link and wireless resource operation. For example, the electronic device may acquire information on wireless resource operation and a link for Wi-Fi direct-based communication and/or information on wireless resource operation and a link for Wi-Fi aware-based communication.

For example, the electronic device may acquire information on a frequency band and a bandwidth of an interface-specific link, and information on a frequency band and a bandwidth of each link according to a communication mode, and acquire information on a scheme of operating a wireless resource allocated to each link. FIG. 15 may be referenced in relation to a scheme of operating a wireless resource. When the electronic device includes multiple chipsets related to communication based on Wi-Fi, the electronic device may acquire chipset-specific link information and information on a resource operation scheme. Such information may be pre-configured in the electronic device, or may be acquired by the electronic device by itself by another method.

In operation 1414, the electronic device may acquire chipset- or interface-specific service, traffic, or constraint information. For example, the electronic device may acquire service, traffic, or other constraint information for Wi-Fi direct-based communication and/or service or traffic limitation, or other constraint information for Wi-Fi aware-based communication. Specifically, such information may include a requirement for a data transmission speed or latency for each service, or a maximum or minimum traffic limitation condition. Such information may be pre-configured in the electronic device, or may be acquired by the electronic device by itself by another method. When the electronic device includes multiple chipsets related to communication based on Wi-Fi, the electronic device may acquire chipset-specific service, traffic, or other constraint information.

In various embodiments, operation 1412 and operation 1414 may be performed in a different order or may be performed simultaneously.

In operation 1416, the electronic device may determine a chipset- or interface-specific communication mode or wireless resource allocation scheme. The electronic device may determine a communication mode or a wireless resource allocation scheme, based on the information acquired in operation 1412 and operation 1414. That is, a communication mode or a wireless resource allocation scheme may be determined based on information on a wireless resource allocated to a chipset- or interface-specific link, a limitation condition for a service or traffic, or other constraint conditions.

In operation 1418, the electronic device may determine whether a condition for changing a configuration is satisfied. The configuration may indicate a configuration related to a communication mode of the electronic device or a configuration related to a wireless resource allocation scheme. The condition for changing the configuration may include at least one of the following conditions.

Condition 1) A connection of an existing interface is terminated. For example, Condition 1 may indicate a case in which Wi-Fi direct-based communication or Wi-Fi aware-based communication currently being performed in the electronic device is terminated.

Condition 2) A connection of a new interface is initiated. For example, Condition 2 may indicate a case in which the electronic device newly initiates Wi-Fi direct-based communication or Wi-Fi aware-based communication. In the case of a TV, Condition 2 may indicate a case in which the TV initiates Wi-Fi direct-based communication with a speaker for an audio service while the TV is receiving service data for streaming through Wi-Fi aware-based communication from an exchange device.

Condition 3) A change in QoS or in an amount of traffic. For example, Condition 3 may indicate a case in which a QoS or an amount of traffic is changed by a particular threshold value or more.

In various embodiments, one of the operations described in FIG. 14 may be omitted, and an order of the operations may be changed. In addition, in relation to the operations described with reference to FIG. 14, multiple operations may be combined and expressed as a single operation, or a single operation may be divided into subdivided operations. The method performed by the electronic device according to embodiments of the disclosure may include an embodiment in which the operations described with reference to FIG. 14 are modified.

The operations described in the embodiment of FIG. 14 may be combined with the operations described in the embodiment of FIG. 9, FIG. 10, FIG. 11, or FIG. 13 to configure a new embodiment.

FIG. 15 illustrates a wireless resource allocation scheme of an electronic device according to an embodiment of the disclosure.

With reference to FIG. 15, an interface (or communication module)-specific scheme of allocating a wireless resource is illustrated. The scheme of allocating a wireless resource may include an alternative-allocation scheme 1510 and fixed-allocation schemes 1520 and 1530.

The alternative-allocation scheme may indicate a scheme in which a frequency band and a bandwidth allocated to each interface over time are changed. Specifically, respective frequency bands for a communication interface based on Wi-Fi aware and a communication interface based on Wi-Fi direct may be periodically changed.

In an embodiment, the communication interface based on Wi-Fi aware and the communication interface based on Wi-Fi direct may perform communication of an MLO mode and communication of a MIMO mode, respectively. When a communication mode is MLO, communication is performed by multiple links, and, in this case, different frequency bands may be allocated to the respective links.

For example, as shown in FIG. 15, in the alternative-allocation scheme 1510, when a communication mode of a first interface is MLO, a first frequency band and a second frequency band may be allocated to two links of the first interface, respectively. And, when a communication mode of a second interface is MIMO, a third frequency band that is not allocated to the first interface may be allocated to a link of the second interface. Since the alternative-allocation scheme is used, a frequency band allocated to each interface may be changed over time, and a communication mode may also be changed. In an example, a frequency band or a communication mode allocated to each interface may be periodically changed.

In various embodiments, a first communication module for supporting Wi-Fi aware and a second communication module for supporting Wi-Fi direct may be configured in a single chipset or may be configured in separate chipsets, respectively. When the first communication module and the second communication module are configured in a single chipset, a scheme in which a different frequency band is allocated to each interface may be understood as the MLO mode from the perspective of the single chipset. For example, when frequency bands are respectively allocated to a plurality of links associated with the first interface (MLO) and a different frequency band is allocated to a single link associated with the second interface (MIMO), a plurality of links are configured from the perspective of the single chipset as a whole, and therefore a corresponding mode may be understood as the MLO mode.

On the contrary, when the first communication module and the second communication module are configured in separate chipsets, respectively, a communication mode may be understood according to a scheme in which a frequency band is allocated from the perspective of each of the chipsets. That is, when multiple links are configured for antenna pairs in a chipset including the first communication module and different frequency bands are allocated to the respective links, a corresponding mode may be understood as the MLO mode from a viewpoint of the chipset. In contrast, when a single link is configured for multiple antenna pairs in a chipset including the second communication module and one frequency band is allocated to the single link, a corresponding mode may be understood as the MIMO mode from a viewpoint of the chipset.

In the alternative-allocation scheme 1510 of FIG. 15, when respective communication modules supporting the first interface and the second interface are configured in one chipset, the application of the MLO mode may be illustrated from a viewpoint of the one chipset. In addition, from the perspective of each interface, the application of the MLO mode or the MIMO mode according to each interface may be illustrated. In the MLO mode or the MIMO mode, the frequency bands allocated to the configured links may differ from each other.

In the fixed-allocation schemes 1520 and 1530, a frequency band and a bandwidth allocated to each interface over time may remain constant. In this regard, the fixed-allocation schemes may include a scheme 1520 in which different frequency bands are constantly allocated over time for respective interfaces, and a scheme 1530 in which an identical frequency band is constantly allocated over time for respective interfaces.

As illustrated in FIG. 15, in a first embodiment 1520, a first frequency band may be allocated to a first interface, and a second frequency band may be allocated to a second interface. In addition, in a second embodiment 1530, an identical frequency band may be allocated to the first interface and the second interface. When a single chipset includes a communication module supporting the first interface and a communication module supporting the second interface, the first embodiment may be understood as the MLO mode from the perspective of the single chipset, whereas the second embodiment may be understood as the MIMO mode. However, when the communication module supporting the first interface and the communication module supporting the second interface are included in respective separate chipsets, the communication modes of the respective chipsets supporting respective interfaces in the first embodiment and the second embodiment may be understood as the MIMO mode.

In a case of the second embodiment 1530, since the same frequency band is allocated to different interfaces, each interface may occupy a wireless resource through mutual contention and perform transmission or reception.

Through an electronic device and a method performed by the same electronic device according to embodiments of the disclosure, even when different network structures are required for services, the services may be simultaneously provided. For example, from the viewpoint of a TV, the TV may be directly connected to a plurality of speakers and directly connected to a set-top box through an exchange device, so that a streaming service and an audio service may be simultaneously implemented on the TV. In addition, according to embodiments of the disclosure, a quality of a wireless connection between electronic devices described above may be improved.

A first electronic device (e.g., a TV, etc.) in a wireless local area network (WLAN) system according to embodiments of the disclosure may include at least one transceiver, and at least one processor connected to the at least one transceiver, wherein the at least one processor includes a first module configured to support a direct connection with a second electronic device (e.g., an exchange device, etc.) for reception of service data, and a second module configured to support a direct connection with at least one third electronic device (e.g., a speaker, etc.) for transmission of service data.

In an embodiment, the first module may indicate a module configured to support a client in direct wireless communication between devices via a central manager without a wireless access point, and the second module may indicate a module configured to support an owner in direct wireless communication between devices via a central manager without a wireless access point. That is, the first module may be a module configured to support a group client based on Wi-Fi direct, and the second module may be a module configured to support a group owner based on Wi-Fi direct. The first module and the second module may be included in a single chipset or included in different chipsets, respectively.

In an embodiment, the first module may be a module configured to support direct wireless communication between devices in a distributed manner without a wireless access point and a central manager, and the second module may be a module configured to support an owner in direct wireless communication between devices via a central manager without a wireless access point. That is, the first module may be a module configured to support communication based on Wi-Fi aware, and the second module may be a module configured to support a group owner based on Wi-Fi direct. The first module and the second module may be included in a single chipset.

In addition, in an embodiment, the first module and the second module may be a module configured to support direct wireless communication between devices in a distributed manner without a wireless access point and a central manager. That is, each of the first module and the second module may be a module configured to support communication based on Wi-Fi aware. In addition, the first module and the second module may be included in a single chipset.

In an embodiment, the at least one processor of the first electronic device may be configured to establish a wireless connection with the second electronic device (e.g., the exchange device), based on the first module, establish a wireless connection with the at least one third electronic device (e.g., the speaker), based on the second module, receive service data for a first service (e.g., a streaming service) from the second electronic device, and transmit service data for a second service (e.g., an audio service) to the at least one third electronic device.

In addition, in an embodiment, the at least one processor may be configured to transmit a first signal for measuring a quality of a connection to the at least one third electronic device, receive a second signal including a measurement value for the first signal from the at least one third electronic device, select a communication mode for the second module, based on the measurement value, and transmit service data to the at least one third electronic device, based on the selected communication mode.

Here, the selected communication mode may include one of a first communication mode (e.g., a MIMO mode) using a link configured based on a single bandwidth for multiple transmission-reception antenna pairs, and a second communication mode (e.g., an MLO mode) using multiple links corresponding to different frequency bands for the respective transmission-reception antenna pairs, the first communication mode may be a multiple input multiple output (MIMO) mode, and the second communication mode may be a multiple link operation (MLO) mode.

In an embodiment, the at least one processor of the first electronic device may be configured to determine whether a condition for evaluating a communication mode is satisfied, and the first signal may be transmitted in case that the condition is satisfied. In this case, the condition may include at least one of a condition in which a new service is initiated, a condition in which an existing service is terminated, a condition in which an amount of data traffic changes by a threshold value or more, and a condition in which a pre-configured time period starts.

In addition, in an embodiment, the first signal may include a pilot packet not including service data or a beacon signal based on Wi-Fi.

Although components of an electronic device and a method performed by the same electronic device according to embodiments of the disclosure are described separately for each embodiment, components included in each embodiment may be combined with components of other embodiments to configure a new embodiment. Accordingly, an embodiment obtained by combining the embodiments of the disclosure may also be understood as being described by the disclosure.

In an embodiment, one or more non-transitory computer-readable storage media storing one or more computer programs including computer-executable instructions that, when executed by one or more processors of an electronic device individually or collectively, cause the electronic device to perform operations, the operations comprising: establishing a connection with a second electronic device, based on a first module configured to support a direct connection with the second electronic device for reception of service data; and establishing a connection with at least one third electronic device, based on a second module configured to support a direct connection with the at least one third electronic device for transmission of service data.

In an embodiment, the operations further comprising: receiving service data for a first service from the second electronic device; and transmitting service data for a second service to the at least one third electronic device.

It should be appreciated that various embodiments of the disclosure and the terms used therein are not intended to limit the technological features set forth herein to particular embodiments and the disclosure includes various changes, equivalents, or alternatives for a corresponding embodiment. As used herein, each of such phrases as "A or B," "at least one of A and B," “at least one of A or B,” "A, B, or C," "at least one of A, B, and C," and “at least one of A, B, or C,” may include all possible combinations of the items enumerated together in a corresponding one of the phrases. Such terms as "a first," "a second," “the first,” and "the second" may be used to simply distinguish a corresponding element from another, and does not limit the elements in other aspect (e.g., importance or order). If an element (e.g., a first element) is referred to, with or without the term “operatively” or “communicatively,” as “coupled with/to” or “connected with/to” another element (e.g., a second element), it means that the element may be coupled/connected with/to the other element directly (e.g., wiredly), wirelessly, or via a third element.

As used in various embodiments of the disclosure, the term "module" may include a unit implemented in hardware, software, or firmware, and may be interchangeably used with other terms, for example, "logic," "logic block," "component," or "circuit." The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software (e.g., a program) including one or more instructions that are stored in a storage medium (e.g., internal memory or external memory) that is readable by a machine (e.g., an electronic device). For example, a processor of the machine (e.g., an electronic device) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Herein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store ^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in any other element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A first electronic device in a wireless local area network (WLAN) system, the first electronic device comprising:
at least one transceiver;
at least one processor communicatively coupled to the at least one transceiver; and
at least one memory, communicatively coupled to the at least one processor, storing instructions executable by the at least one processor individually or in any combination,
wherein the at least one processor comprises:
a first module configured to support a direct connection with a second electronic device for reception of service data, and
a second module configured to support a direct connection with at least one third electronic device for transmission of service data.

2. The first electronic device of claim 1,
wherein the first module is configured to support a client in direct wireless communication between devices via a central manager without a wireless access point,
wherein the second module is configured to support an owner in direct wireless communication between devices via a central manager without a wireless access point, and
wherein the first module and the second module are included in a single chipset or included in different chipsets, respectively.

3. The first electronic device of claim 1,
wherein the first module is configured to support direct wireless communication between devices in a distributed manner without a wireless access point and a central manager,
wherein the second module is configured to support an owner in direct wireless communication between devices via a central manager without a wireless access point, and
wherein the first module and the second module are included in a single chipset.

4. The first electronic device of claim 1,
wherein the first module and the second module are configured to support direct wireless communication between devices in a distributed manner without a wireless access point and a central manager, and
wherein the first module and the second module are included in a single chipset.

5. The first electronic device of claim 1, wherein the instructions further cause the first electronic device to:
establish a wireless connection with the second electronic device, based on the first module;
establish a wireless connection with the at least one third electronic device, based on the second module;
receive service data for a first service from the second electronic device; and
transmit service data for a second service to the at least one third electronic device.

6. The first electronic device of claim 1, wherein the instructions further cause the first electronic device to:
transmit, to the at least one third electronic device, a first signal for measuring a quality of a connection;
receive a second signal including a measurement value for the first signal from the at least one third electronic device;
select a communication mode for the second module, based on the measurement value; and
transmit service data to the at least one third electronic device, based on the selected communication mode.

7. The first electronic device of claim 6,
wherein the selected communication mode comprises one of a first communication mode using one link configured based on a single bandwidth for multiple transmission-reception antenna pairs, or a second communication mode using multiple links corresponding to different frequency bands for the respective transmission-reception antenna pairs, and
wherein the first communication mode comprises a multiple input multiple output (MIMO) mode, and the second communication mode comprises a multiple link operation (MLO) mode.

8. The first electronic device of claim 6,
wherein the instructions further cause the first electronic device to determine whether a condition for evaluating a communication mode is satisfied, and
wherein the first signal is transmitted in case that the condition is satisfied.

9. The first electronic device of claim 8, wherein the condition comprises at least one of a condition in which a new service is initiated, a condition in which an existing service is terminated, a condition in which an amount of data traffic changes by a threshold value or more, or a condition in which a preconfigured time period arrives.

10. The first electronic device of claim 6, wherein the first signal comprises a pilot packet not including service data or a Wi-Fi-based beacon signal.

11. A method performed by a first electronic device in a wireless local area network (WLAN) system, the method comprising:
establishing a connection with a second electronic device, based on a first module configured to support a direct connection with the second electronic device for reception of service data; and
establishing a connection with at least one third electronic device, based on a second module configured to support a direct connection with the at least one third electronic device for transmission of service data.

12. The method of claim 11,
wherein the first module is configured to support a client in direct wireless communication between devices via a central manager without a wireless access point,
wherein the second module is configured to support an owner in direct wireless communication between devices via a central manager without a wireless access point, and
wherein the first module and the second module are included in an identical chipset or included in different chipsets, respectively.

13. The method of claim 11,
wherein the first module is configured to support direct wireless communication between devices in a distributed manner without a wireless access point and a central manager,
wherein the second module is configured to support an owner in direct wireless communication between devices via a central manager without a wireless access point, and
wherein the first module and the second module are included in an identical chipset.

14. The method of claim 11,
wherein the first module and the second module are configured to support direct wireless communication between devices in a distributed manner without a wireless access point and a central manager, and
wherein the first module and the second module are included in an identical chipset.

15. The method of claim 11, further comprising:
receiving service data for a first service from the second electronic device; and
transmitting service data for a second service to the at least one third electronic device.

16. The method of claim 11, further comprising:
transmitting, to the at least one third electronic device, a first signal for measuring a quality of a connection;
receiving a second signal including a measurement value for the first signal from the at least one third electronic device;
selecting a communication mode for the second module, based on the measurement value; and
transmitting service data to the at least one third electronic device, based on the selected communication mode.

17. The method of claim 16,
wherein the selected communication mode comprises one of a first communication mode using one link configured based on a single bandwidth for multiple transmission-reception antenna pairs, or a second communication mode using multiple links corresponding to different frequency bands for the respective transmission-reception antenna pairs, and
wherein the first communication mode comprises a multiple input multiple output (MIMO) mode, and the second communication mode comprises a multiple link operation (MLO) mode.

18. The method of claim 16, further comprising determining whether a condition for evaluating a communication mode is satisfied,
wherein the first signal is transmitted in case that the condition is satisfied.

19. The method of claim 18, wherein the condition comprises at least one of a condition in which a new service is initiated, a condition in which an existing service is terminated, a condition in which an amount of data traffic changes by a threshold value or more, or a condition in which a preconfigured time period arrives.

20. The method of claim 16, wherein the first signal comprises a pilot packet not including service data or a Wi-Fi based beacon signal.
